(19) United States
(12) Patent Application Publication
(10) Pub. No.: US 2024/0362068 A1
(43) Pub. Date: Oct. 31, 2024

(54) PREDICTIVE MACHINE LEARNING TECHNIQUES FOR OPTIMAL RESOURCE ALLOCATION USING NONLINEAR CAUSAL INFERENCE

(71) Applicant: Optum Services (Ireland) Limited, Dublin (IE)

(72) Inventors: Breanndan O CONCHUIR, Warrington (GB); Conor John WALDRON, Dublin (IE); Michael J. MCCARTHY, Co Dublin (IE); Kevin A. HEATH, Dublin (IE)

(21) Appl. No.: 18/307,033

(22) Filed: Apr. 26, 2023

(51) Int. Cl. G06F 9/50; G06N 5/022

(52) U.S. Cl. CPC G06F 9/5027; G06N 5/022

(57) ABSTRACT

Various embodiments of the present disclosure provide methods, apparatus, systems, computing devices, computing entities, and/or the like for improving allocation of limited resources by generating an optimization function for generating an optimal amount of resources to allocate to data objects in each of one or more data object cohorts based on nonlinear causal effect predictions and generating an optimal parameter occurrence set based on the determined optimal amount of resource. Nonlinear causal effects of selected amounts of type-varied resources assigned to specific data objects are predicted on an outcome of interest associated with the data objects.

### BACKGROUND

Various embodiments of the present disclosure address technical challenges related to managing computing systems with finite resources of multiple types and allocating resources of various types most effectively. Existing processes for allocating resources of various types, such as clinical care resources, rely on generic deterministic rules or associative frameworks. Such techniques may fail to account for interrelated effects of allocating resources of various types on a target objective. Accordingly, such techniques may inefficiently allocate resources due to an inability to identify and account for relationships between allocations of various combinations of resource types and a predictive outcome of the target objective. Traditionally, these technical shortcomings to identifying optimal allocations of type-varied resources result in wasteful and, therefore, costly resource management outcomes. Various embodiments of the present disclosure make important contributions to various existing resource allocation techniques by addressing these technical challenges.

### BRIEF SUMMARY

Various embodiments of the present disclosure provide methods, apparatus, systems, computing devices, computing entities, and/or the like for generating an optimization function for predicting an optimal number of parameter occurrences of a plurality of outcome-influencing data types to be allocated to one or more data objects in order to optimize a predictive outcome for the data object(s). The prediction systems and processes described herein may generate optimization functions for generating optimal parameter occurrence sets for one or more data objects. The optimal parameter occurrence set may indicate an optimal number of parameter occurrences of a plurality of outcome-influencing data types to assign to a data object. The allocation of a parameter occurrence of an outcome-influencing data type to a data object may be leveraged to generate predictive recommendations for providing particular amounts of resources to and/or for enacting particular amounts of resources upon the data object(s). The present prediction systems and processes may generate optimal parameter occurrence sets based on nonlinear causal modeling, potentially in combination with other techniques described herein, to optimize a predictive outcome for the data object(s). Further, in some embodiments, the present prediction systems and processes generate optimal parameter occurrence sets that minimize a predictive cost of the predictive outcome. Thus, in various embodiments, the present prediction systems and processes provide a technical solution for efficiently allocating resources of differing types to one or more data objects respective to a target predictive outcome for the data object(s) and while minimizing a predictive cost of achieving the predictive outcome. In doing so, the present prediction systems and processes may maximize resource allocation efficiency for resources of differing type while minimizing resource utilization and/or predictive resource costs.

In some embodiments, a computer-implemented method includes identifying, by one or more processors, a plurality of outcome-influencing data types for a dataset comprising a plurality of data objects, wherein each of the plurality of data objects is associated with a number of parameter occurrences for each of the plurality of outcome-influencing data types; generating, by the one or more processors, a causal relationship representation based on the dataset, wherein the causal relationship representation is indicative of a causal relationship between each of the plurality of outcome-influencing data types and a predictive outcome of the plurality of data objects; generating, by the one or more processors, an optimization function using the causal relationship representation, wherein the optimization function is configured to generate an optimal parameter occurrence set for a data object of the plurality of data objects, and the optimal parameter occurrence set is indicative of an optimal number of parameter occurrences for each of the plurality of outcome-influencing data types; and providing, by the one or more processors, data indicative of the optimization function.

In some embodiments, a computer apparatus comprises memory and one or more processors communicatively coupled to the memory, the one or more processors configured to identify a plurality of outcome-influencing data types for a dataset comprising a plurality of data objects, wherein each of the plurality of data objects is associated with a number of parameter occurrences for each of the plurality of outcome-influencing data types; generate a causal relationship representation based on the dataset, wherein the causal relationship representation is indicative of a causal relationship between each of the plurality of outcome-influencing data types and a predictive outcome of the plurality of data objects; generate an optimization function using the causal relationship representation, wherein the optimization function is configured to generate an optimal parameter occurrence set for a data object of the plurality of data objects, and the optimal parameter occurrence set is indicative of an optimal number of parameter occurrences for each of the plurality of outcome-influencing data types; and provide data indicative of the optimization function.

In some embodiments, one or more non-transitory, computer-readable storage media including instructions that, when executed by one or more processors, cause the one or more processors to identify a plurality of outcome-influencing data types for a dataset comprising a plurality of data objects, wherein each of the plurality of data objects is associated with a number of parameter occurrences for each of the plurality of outcome-influencing data types; generate a causal relationship representation based on the dataset, wherein the causal relationship representation is indicative of a causal relationship between each of the plurality of outcome-influencing data types and a predictive outcome of the plurality of data objects; generate an optimization function using the causal relationship representation, wherein the optimization function is configured to generate an optimal parameter occurrence set for a data object of the plurality of data objects, and the optimal parameter occurrence set is indicative of an optimal number of parameter occurrences for each of the plurality of outcome-influencing data types; and provide data indicative of the optimization function.

### BRIEF DESCRIPTION OF THE DRAWINGS

FIG. 1 provides an example overview of an architecture that may be used to practice embodiments of the present disclosure.

FIG. 2 provides an example predictive data analysis computing entity in accordance with some embodiments discussed herein.

FIG. 3 provides an example client computing entity in accordance with some embodiments discussed herein.

FIG. 4 provides an example dataflow diagram of a technique for generating an optimal parameter occurrence set for one or more data objects in accordance with some embodiments discussed herein.

FIG. 5 provides an example architecture of historical data in a clinical prediction domain in accordance with some embodiments discussed herein.

FIG. 6 provides an example architecture of knowledge graph data in a clinical prediction domain in accordance with some embodiments discussed herein.

FIG. 7 provides an operational example of a directed acyclic graph in a clinical prediction domain in accordance with some embodiments discussed herein.

FIG. 8 provides operational examples of causal relationship representations in a clinical prediction domain in accordance with some embodiments discussed herein.

FIG. 9 provides operational examples of causal relationships generated by a causal relationship representation in a clinical prediction domain in accordance with some embodiments discussed herein.

FIG. 10 is a flowchart diagram of an example process for determining optimal parameter occurrence sets for one or more data objects in accordance with some embodiments described herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that include articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component including assembly language instructions may require conversion into executable machine code by an assembler prior to execution by the hardware architecture and/or platform. Another example programming language may be a higher-level programming language that may be portable across multiple architectures. A software component including higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component including instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that includes combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

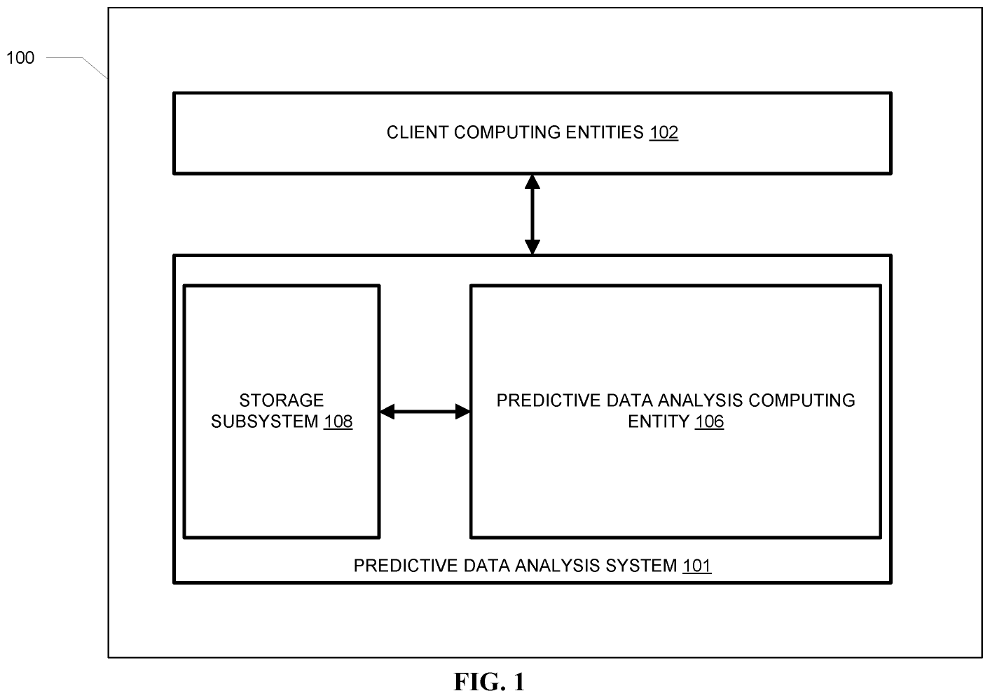

FIG. 1 provides an example overview of architecture 100 that may be used to practice embodiments of the present disclosure. The architecture 100 includes a predictive data analysis system 101 configured to receive predictive data analysis requests from client computing entities 102, process the predictive data analysis requests to generate predictions, provide the generated predictions to the client computing entities 102, and automatically initiate performance of prediction-based actions based on in part on the generated predictions.

An example of a prediction-based action that may be performed using the predictive data analysis system 101 includes a response to receiving a request for allocating a plurality of parameter occurrences of a plurality of outcome-influencing data types to one or more data objects. The response may include performing a resource-based allocation action (e.g., generating an optimal parameter occurrence set for allocating parameter occurrences of the plurality of outcome-influencing data types), generating a diagnostic report, generating action scripts, generating alerts or messages, and generating one or more electronic communications based on an optimal parameter occurrence set for each data object, or cohort of data objects.

In accordance with various embodiments of the present disclosure, a resource allocation machine learning framework may be configured to determine data object cohorts benefiting most from one or more resource allocations of a first resource type, one or more allocations of a second resource type, and potentially other allocations of resources of other resource types, based on a nonlinear causal effect prediction. In some embodiments, the parameter occurrence allocation machine learning framework may include a nonlinear causal inference machine learning model that is trained to predict nonlinear causal effects of allocating various combinations of parameter occurrences of a plurality of outcome-influencing data types to data objects for a predictive outcome, or predictive cost thereof, based on historical data and directed acyclic graph data. In some embodiments, one or more nonlinear causal effect predictions of one or more causal variables (e.g., amount of resource allocation of each resource type) on an outcome of interest may be performed based on historical data and directed acyclic graph data. This technique may lead to higher success of multi-resource type resource allocation operations as needed for certain data objects. In doing so, the techniques described herein improve efficiency and quality-of-service. Accordingly, the techniques described herein improve at least one of the computational efficiency, storage-wise efficiency, and operational efficiency of computational systems.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically initiate performance of prediction-based actions based on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

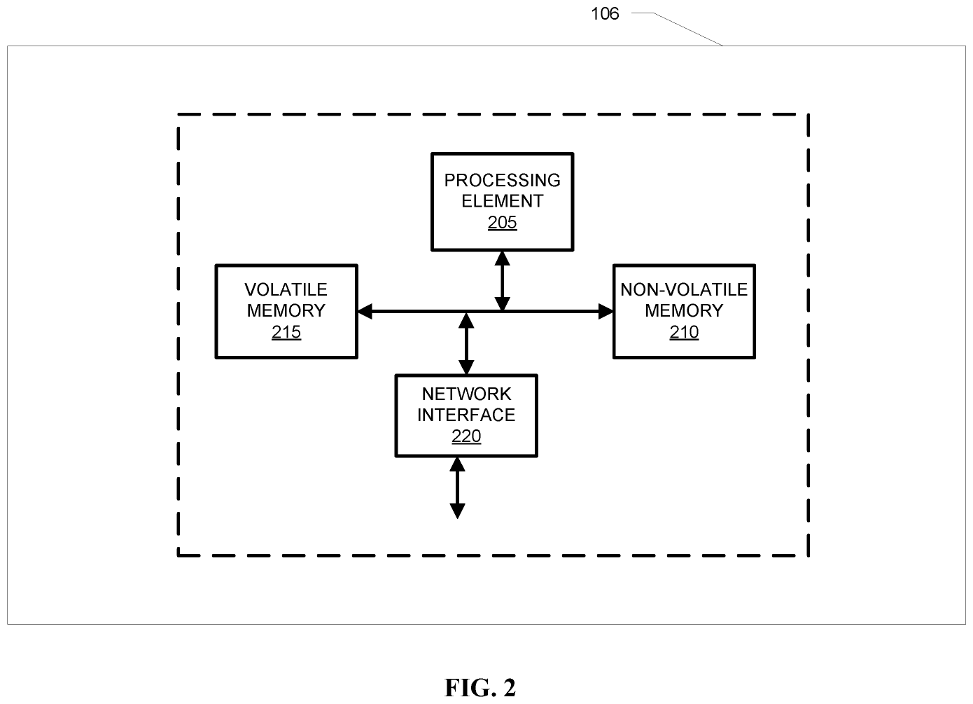

FIG. 2 provides an example predictive data analysis computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the predictive data analysis computing entity 106 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the predictive data analysis computing entity 106 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry, and/or similar terms used herein interchangeably). In one embodiment, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

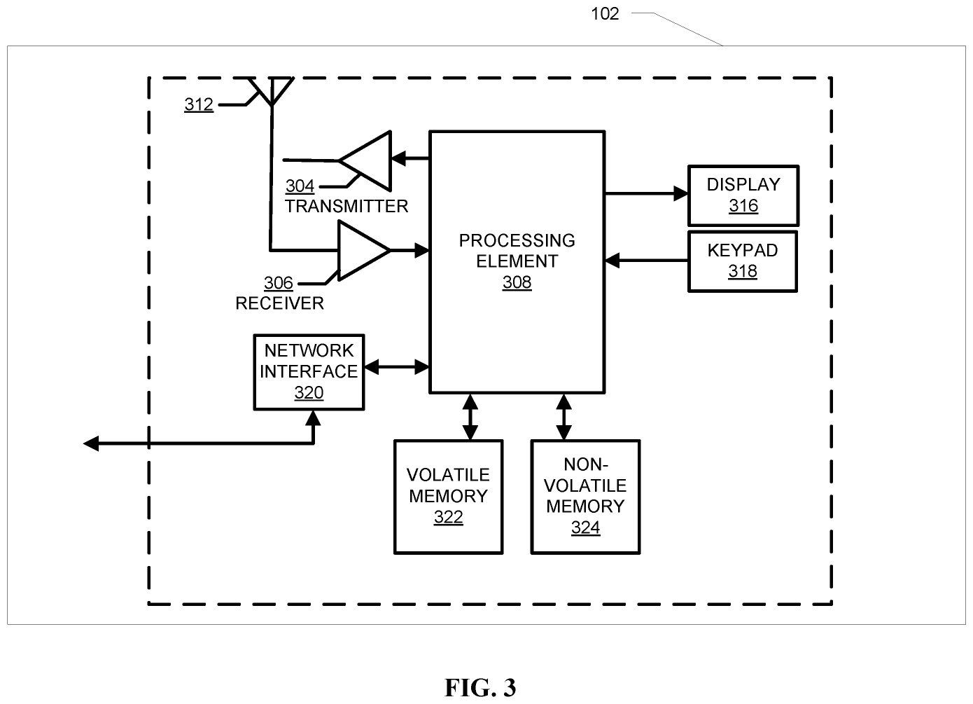

FIG. 3 provides an example client computing entity 102 in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also include a user interface (that may include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface may include any of a number of devices or interfaces allowing the client computing entity 102 to receive data, such as a keypad 318 (hard or soft), a touch display, voice/speech or motion interfaces, gesture recognition sensor(s), or other input device. In embodiments including a keypad 318, the keypad 318 may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, a gesture-activated input, and/or the like. In certain embodiments, an AI computing entity may include one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “data object” refers to a data construct that describes an object, article, file, program, service, task, operation, computing, and/or the like unit that receives resources or actions as a resource (generally referred to herewith as allocation of resource(s)), to execute an operation, perform a task, maintain or advance a state, or continue functioning. In some embodiments, a data object is allocated a number of parameter occurrences for each of a plurality of outcome-influencing data types based upon one or more conditional factors (e.g., as may be determined by a policy), one or more frequential factors (e.g., as may be determined by scarcity), or based on a combination of conditional and frequential factors. For example, a computing device may determine whether to allocate any number of parameter occurrences of each of a plurality of outcome-influencing data types to a data object.

In some embodiments, the terms “plurality of data objects,” “data object set,” or “cohort of data objects” refers to a data construct that describes a group of data objects, such as, for example, members that share a defining characteristic or criteria. In some embodiments, the present prediction systems and processes generate data object cohorts based on a clustering of data objects from a dataset including historical data. In some embodiments, data object cohorts are generated based on grouping of data objects having similar values for one or more selected variables (causal or non-causal).

In some embodiments, the term “outcome-influencing data type” refers to a type of a particular resource or plurality of resources. In some embodiments, an outcome-influencing data type refers to types of resources, the occurrence or provisioning of which may influence an outcome associated with one or more data objects. For example, a first outcome-influencing data type may be associated with a first set of resources and a second outcome-influencing data type may be associated with a second set of resources. In this example, an outcome for a particular data object may be influenced based on an allocation of the first set of resources to the particular data object and an allocation of the second set of resources to the particular data object. In some embodiments, the allocation of a parameter occurrence of an outcome-influencing data type to a data object refers to allocation of a resource, or plurality of resources, to the data object, such as where the resource is an action to be performed respective to or including the data object, a service to be provided to the data object, an event to occur with respect to the data object, an asset to be provisioned to the data object, or combinations thereof.

In some embodiments, the term “resource” refers to a data construct that describes a physical or virtual component of limited availability, such as within or may be provided by a computer system. For example, connected devices and system components may be accessed as resources. In some embodiments, virtual resources include files, network connections, and/or memory areas. Additional examples of resources may include, but are not limited to, computation time, a number of steps necessary to solve a problem, processes, tasks, services, and memory space, such as an amount of storage needed while solving the problem. In some embodiments, a resource is associated with a stock or supply of money, materials, staff, support, and other assets that may be drawn on by a computing system. As described, in some embodiments, a resource is associated with one or more outcome-influencing data types. In some embodiments, a provisioning of a resource to a data object is referred to as an “occurrence” of the resource, or, more generally, an occurrence of the outcome-influencing data type(s) associated with the resource. For example, a quantity of a particular resource of a particular outcome-influencing data type to a data object may be referred to as a number of “parameter occurrences” of the particular outcome-influencing data type. In some embodiments, the prediction systems and processes generate, for one or more data objects and corresponding to a target predictive outcome, one or more optimal parameter sets. In some embodiments, the optimal parameter set(s) include optimal numbers of parameter occurrences (e.g., amounts of resource allocation) for at least a first outcome-influencing data type (e.g., first type of resource) and a second outcome-influencing data type (e.g., second type of resource).

In some embodiments, the term “historical data” refers to a data construct that describes a recording of structured and/or unstructured data associated with actions, such as parameter occurrence allocations, with respect to one or more data objects and predictive outcomes as a result of the actions. For example, the present prediction systems and processes may utilize one or more datasets that include a plurality of data objects and respective historical data for each of the plurality of data objects, or at least a subset thereof. In some embodiments, historical data includes data records associated with one or more predictive outcomes for one or more data objects. In some embodiments, a data record includes one or more of, but is not limited to, one or more causal variables, respective causal variable values of the one or more causal variables, actions, one or more outcome values associated with the one or more causal variables with the respective causal variable values and the actions, and a pre-defined time window. As an example, historical data may include a log of activity, events, diagnosis, conditions, demographics, statistics, actions or procedures, and any other information associated with the one or more data objects. In some embodiments, the historical data is stored in a database and provided as input to the present prediction systems and processes for generating a causal relationship representation and/or an optimization function for generating an optimal parameter occurrence set.

In some embodiments, the term “parameter occurrence” refers to a data construct that describes an independent variable associated with an outcome-influencing data type that produces a causal effect that may be either linear or nonlinear. For example, the parameter occurrence may refer to a causal variable. In some embodiments, a parameter occurrence includes a data variable associated with a quantity of actions (e.g., number of parameter occurrences of an outcome-influencing data type) allocated to a data object. In some embodiments, a causal effect on a predictive outcome associated with a data object is attributed to a particular number of parameter occurrences for a particular outcome-influencing data type (e.g., when allocated to one or more data objects in combination with at least a second number of parameter occurrences for at least one additional outcome-influencing data type). In some embodiments, a number of parameter occurrences of each of a plurality of outcome-influencing data types effects a linear or nonlinear change in a predictive outcome associated with a data object. In some embodiments, the linear or nonlinear change effected by parameter occurrences of each outcome-influencing data type is influenced by parameter occurrences of other outcome-influencing data types. For example, the present prediction systems and processes may predict such interrelated causal effects, thereby improving efficiency and accuracy of parameter occurrence allocations of a plurality of outcome-influencing data types to a data object or cohort of data objects.

In some embodiments, the term “number of parameter occurrences” refers to a data construct that describes a quantitative value of a causal variable. For example, a causal variable may represent quantity of actions (e.g., parameter occurrence of an outcome-influencing data type) and a causal variable value for the causal variable may include a numerical value corresponding to the quantity of actions. In some embodiments, an outcome-influencing data type represents a data field for a causal variable and a number of parameter occurrences for the outcome-influencing data type may include a binary, decimal, or hexadecimal value representative of an existence of an attribute and/or a descriptor of the data field. The number of parameter occurrences may correspond to a level of allocation of a resource of a particular outcome-influencing data type to one or more data objects. The present prediction systems and processes may generate a predicted causal effect of a number of parameter occurrences (causal variable value) on a predictive outcome associated with one or more data objects and/or one or more outcome-influencing data types. The present prediction systems and processes may generate the predicted causal effect of a first causal variable (e.g., first outcome-influencing data type) on a predictive outcome in a manner that accounts for outcome-influencing effects of additional causal variables (e.g., additional outcome-influencing data types), thereby differentiating the prediction systems and processes over previous approaches that predict nonlinear causal effects a single causal variable in isolation.

In some embodiments, the term “causal relationship” refers to a linear or nonlinear relationship between one or more causal effect variables, such as numbers of parameter occurrences for a plurality of outcome-influencing data types, and a causal effect, such as a predictive outcome for a data object. The causal relationship may include one or more predicted causal effect values for a value of a causal variable (e.g., number of parameter occurrences of an outcome-influencing data type) on a predictive outcome, or one or more aspects thereof, such as a predictive cost of the predictive outcome.

In some embodiments, the term “causal relationship representation” refers to a data construct that describes one or more causal relationships. For example, the causal relationship representation may refer to, or include, parameters, hyperparameters, and/or defined operations of a machine learning model that is configured to generate one or more nonlinear causal effect predictions of one or more causal variables on a predictive outcome associated with a data object based on historical data and knowledge graph data. In some embodiments, the present predictions systems and processes generate a causal relationship representation using one or more supervised machine learning regression techniques and/or models, such as a non-parametric double machine learning model or a non-parametric double/debiased machine learning model.

In some embodiments, the term “supervised machine learning regression” refers to analysis performed by a machine learning model, such as a double/debiased machine learning model, to model a relationship between one or more independent variables (e.g., causal variables, such as parameter occurrences) and a dependent variable (e.g., predictive outcome for one or more data objects). In some embodiments, a supervised machine learning regression include identifying or determining an effect of causal variables (e.g., allocation of parameter occurrences for different outcome-influencing data types) on a predictive outcome for members of a selected data object cohort over a period of time (e.g., 1 month, 1 year, or any suitable period). For example, supervised machine learning regression may include a prediction of a continuous value that forecasts a trend by generating a causal relationship representation associated with a plurality of predictive outcome values (e.g., absolute values, deltas, or other suitable statistical measures of predictive outcome) and a plurality of causal variable values (e.g., various numbers of parameter occurrences for a plurality of outcome-influencing data types). In some embodiments, the generated causal relationship representation includes a best-fit curve between data values of a plot between the plurality of outcome values and the plurality of causal variable values of one or more causal variables, such as one or more outcome-influencing data types.

In some embodiments, the term “optimization function” refers to an estimation function for predicting nonlinear causal effects of one or more causal variables, such as numbers of parameter occurrences for a plurality of outcome-influencing data types, on a causal effect (e.g., a predictive outcome for one or more data objects). For example, the optimization function may refer to a data construct that describes parameters, hyperparameters, and/or defined operations of a machine learning model that is configured to: (i) determine, for each causal variable value selected from a plurality of causal variable values, an outcome value for one or more data objects based on the historical data, and/or (ii) determine an optimal causal variable value for each of a plurality of outcome-influencing data types by applying supervised machine learning regression to a plurality of outcome values associated with one or more data objects based on one or more of a directed acyclic graph, historical data, and a causal relationship representation. In some embodiments, based on the causal relationship representation, the optimization function generates an optimal parameter occurrence set for one or more data objects, where the optimal parameter occurrence set is indicative of an optimal number of parameter occurrences for each of a plurality of outcome-influencing data types respective to a predictive outcome for the data object(s).

In some embodiments, the term “predictive outcome” refers to a data construct that describes a dependent variable that may be varied based on causal variable values selected for one or more causal variables. For example, a predictive outcome may represent a desired state or condition of a data object, such as a cost of allocating parameter occurrences of various outcome-influencing data types to the data object. In some embodiments, a predictive outcome corresponds to a causal effect of a plurality of causal variables, which may be a set of parameter occurrences for a plurality of outcome-influencing data types. In one example, a predictive outcome may include a predictive cost of providing a particular number of parameter occurrences of a plurality of outcome-influencing data types to one or more data objects. In another example, a predictive outcome may include a resource utilization metric that estimates an amount of resources required to provide a particular number of parameter occurrences of a plurality of outcome-influencing data types to one or more data objects.

In some embodiments, the term “optimal number” refers to a data construct that describes a causal variable value. For example, the optimal number may refer to a maximum value on a causal relationship representation associated with a data object cohort. In some embodiments, the optimal number refers to a minimum value on a causal effect curve associated with a data object cohort. For example, the optimal number may refer to a number of parameter occurrences for each of a plurality of outcome-influencing data types associated with a minimum value of cost for a program that includes providing the number of parameter occurrences to one or more data objects and allocating resources to account for one or more causal effects thereof. In some embodiments, “optimal number” is used interchangeably with “optimal value.”

In some embodiments, the term “optimal parameter occurrence set” refers to instructions or logic for varying parameter occurrence values of a plurality of outcome-influencing data types for a plurality of data object cohorts (e.g., or a subset of the plurality of data object cohorts) based on an aggregate of optimal parameter occurrence values generated for the plurality of data object cohorts. For example, an “optimal occurrence set” may refer to a plurality of optimal numbers of parameter occurrences where each optimal number of parameter occurrences in the set is associated with a different outcome-influencing data type.

In some embodiments, the term “knowledge graph” refers to a data construct that describes expert knowledge data including one or more relationships between various causal variables (e.g., a plurality of outcome-influencing data types), actions (e.g., allocation of parameter occurrences of the plurality of outcome-influencing data types), and predictive outcomes. For example, a knowledge graph may include a directed acyclic graph data object that is representative of a causal diagram including assumptions, such as, for example, variables to control for (e.g., accounting for extraneous or non-causal variables), and relationships (e.g., directed) between different causal variables (e.g., independent variables), confounders, and outcomes (e.g., dependent variables). Data associated with a knowledge graph may be referred to as “knowledge graph data.” In some embodiments, knowledge graph data is stored on one or more databases and retrieved as input to a causal inference machine learning model to impart expert knowledge about relationships between different data points. In some embodiments, a knowledge graph includes directionality and/or monotonicity of how variable ‘X’ causes variable ‘Y’ (and not vice versa), of how variable ‘Z’ depends on variable ‘X’ but not on variable ‘Y,’ of how variable ‘W’ causes variables ‘Z’ and ‘Y’ but not variable ‘X.’

In some embodiments, the term “party” refers to a source or entity associated with an outcome-influencing data type. For example, the party may refer to a provider of a particular type of resource. In some embodiments, the party refers to a particular set of computing resources, a location, an action, a service, an asset, or combinations thereof. In some embodiments, the party refers to any entity with capacity to enter into an entity interaction with a data object.

In some embodiments, the term “entity interaction” refers to data describing any action, service, asset, or other modification provisioned or acted upon a data object. For example, the entity interaction may refer to an action performed between a party and the data object using a particular set of computing resources. As another example, the entity interaction may refer to a service enacted by a party upon a data object, or otherwise performed for the data object. In some embodiments, an outcome-influencing data type indicates a type of entity interaction between a party and one or more data objects. In some embodiments, the entity interaction is associated with, or includes, one or more interaction attributes.

In some embodiments, the term “interaction attribute” includes data that describes or defines one or more conditions, properties, or other criteria of an entity interaction. In some embodiments, the interaction attribute includes one or more of, but is not limited to, location attributes, communication mode attributes, temporal attributes, task attributes, and combinations thereof. As one example, the interaction attribute may refer to a location for a parameter occurrence of an outcome-influencing data type. As another example, the interaction attribute may refer to a communication mode by which a parameter occurrence of an outcome-influencing data type occurs between a party and a data object.

In some embodiments, the term “location attribute” refers to data describing one or more locational aspects of an entity interaction. For example, the location attribute may refer to one or more of a physical location, a virtual location, a location variable (e.g., distance between two locations), location groupings, affiliations, and/or categories, and combinations thereof. The location attribute may specify whether a location is local or remote to a second location. For example, the location attribute may specify whether a resource associated with a particular outcome-influencing data type is local or remote to a location of a data object.

In some embodiments, the term “communication mode attribute” refers to a manner by which an entity interaction between a party and one or more data objects occurs. For example, the communication mode attribute may refer to one or more of a physical interaction between a party and a data object, a virtual interaction between a party and a data object, or a particular type of virtual interaction between a party and a data object (e.g., telephonic, electronically mailed, virtualized reality, augmented reality, etc.), and combinations thereof.

In some embodiments, the term “temporal attribute” refers to data describing or defining timing-related aspects of entity interactions. For example, the temporal attribute may refer to one or more of a duration of an entity interaction, an initialization time for an entity interaction, a termination time for an entity interaction, a frequency for the entity interaction, a movement duration and/or distance associated with members of an entity interaction, and combinations thereof.

In some embodiments, the term “task attribute” refers to actions performed, assets provisioned, and/or services rendered during or in association with an entity interaction. For example, the task attribute may refer to a screening, assay, diagnostic, treatment, modification, or other action performed on a data object during an entity interaction. In some embodiments, the task attribute refers to a particular type, or types, of party(ies) associated with an entity interaction. In some embodiments, the task attribute identifies a particular resource set, service history, and/or specialization with which a party is associated.

In some embodiments, the term “rule set” refers to data objects that describe, define, or otherwise configure a policy, threshold, criteria, or other constraint to a parameter occurrence value, a combination of parameter occurrence values, or a predictive outcome. In some examples, the rule set may be indicative of one or more parameters for constraining an optimal parameter occurrence set. In addition, or alternatively, the rule set may be associated with one or more different parties. By way of example, the rule set may include a party-specific rule set that is indicative of one or more party-specific parameters for constraining an optimal parameter occurrence set. The party-specific parameters, for example, may be based on one or more organizational policies, and/or the like for allocated resources across a population.

In some embodiments, the rule set is received by the present prediction system from a client computing device. In some embodiments, the rule set may be generated based on historical data and/or knowledge graph data. In some examples, a rule set may include a maximum value and/or a minimum value for a number of parameter occurrences of a first outcome-influencing data type. In addition, or alternatively, the rule set may include a second maximum value and/or a second minimum value for a number of parameter occurrences for a second outcome-influencing data type. In some examples, the rule set may include a maximum value for a predictive outcome for one or more data objects. In addition, or alternatively, the rule set may include a minimum value for a predictive outcome for one or more data objects.

### IV. OVERVIEW AND TECHNICAL IMPROVEMENTS

Some embodiments of the present disclosure present techniques and processes for generating optimization functions configured for generating optimal parameter occurrence sets to improve upon traditional resource allocation and prediction techniques in complex prediction domains. Complex prediction domains, such as clinical domains, are associated with resources of many different data types. The resources of each data type, and quantity thereof, allocated to a data object may demonstrate various causal effects, alone and in combination, on a predictive outcome for the data object. For example, a predictive outcome for a data object may be influenced by a first quantity of resources of a first data type allocated to the data object, and the predictive outcome for the data object may also be influenced by a second quantity of resources of a second data type allocated to the data object. Further, in this example, the influences of the first quantity of resources and the second quantity of resources on the predictive outcome may be interrelated such that effective optimization of overall resource allocation may be best achieved by considering the interrelated effects of each type and quantity of resource allocated to the data object. The prediction systems and processes described herein may address such technical challenges by providing and applying machine learning techniques for optimally allocating resources of differing types to selected data objects based on nonlinear causal inference.

Various embodiments of the present disclosure make important technical contributions to improving allocation of limited resources. In particular, various embodiments of the present disclosure include systems and corresponding methods for generating optimization functions configured to (1) determine an optimal number of parameter occurrences of various outcome-influencing data types to allocate to data objects in each of one or more data object cohorts based on nonlinear causal effect predictions, and, in some embodiments, (2) generate an optimal parameter occurrence set indicative of the optimal number of parameter occurrences for each of the various outcome-influencing data types. In doing so, the techniques described herein improve performance, e.g., resource-to-benefit, outcomes of any given computing system. Accordingly, the techniques described herein improve at least one of the computational efficiency, storage-wise efficiency, and operational efficiency of computational systems.

For example, various embodiments of the present disclosure improve allocation of parameter occurrences of various outcome-influencing data types by generating optimization functions configured for predicting nonlinear causal effect of selected numbers of parameter occurrences of the various outcome-influencing data types assigned to specific data objects on a predictive outcome. As described herein, computing systems may have finite numbers of parameter occurrences (e.g., resources) available to fulfill requests or meet obligations. Further, computing systems may have target predictive outcomes, such as a maximum level of resource utilization, and, potentially, predictive outcome restraints, such as a maximum predictive cost for the predictive outcome. As such, there exists an unmet need to optimally and efficiently allocate resources of differing data types to selected data objects based on the predicted influence of the resources on the predictive outcome for the selected data objects. As one example, a first cohort of data objects may demonstrate an optimal level of a causal benefit when allocated a first combination of parameter occurrences of a plurality of outcome-influencing data types, whereas a second cohort of data objects may demonstrate an optimal level of the causal benefit when allocated a second combination of parameter occurrences of the plurality of outcome-influencing data types. Various embodiments of the present prediction systems and processes output, for one or more data objects, an optimization function configured for generating one or more optimal parameter occurrence sets for a plurality of outcome-influencing data types to optimize a causal benefit for the data object(s) and/or minimize, or otherwise optimize, a causal effect, such as a cost of managing the data object(s) or providing or enacting resources to or upon the data object(s). To effectively distribute parameter occurrences of outcome-influencing data types, some embodiments of the present disclosure predict nonlinear causal effects of each outcome-influencing data type on a predictive outcome. Further, in some embodiments, the present prediction systems and processes predict nonlinear causal effects based on historical data and knowledge graph data associated with different cohorts of data objects, thereby capturing the different requirements of each cohort of data objects and improving the specificity of each optimal parameter occurrence set to the corresponding cohort of data objects.

Existing techniques may include assessing data objects based on historical activity and predicted future cost computed using either deterministic rules or with an associative artificial intelligence predictive model. The assessment may be used to categorize data objects into different risk levels, with the most-critical data objects in a highest risk group. Each risk level may then be assigned a standard number of resources based on e.g., system default values.

However, such a technique is limited in its application in determining whether additional allocation of parameter occurrences of a particular outcome-influencing data type will provide added benefit to certain data objects because they may only be used to identify data objects that require resources. Such a technique is incapable of estimating the impact of each resource allocation. As such, the aforementioned technique is used for prioritization of data objects and allocation of scarce resources, under the assumption that data objects with the greatest risk of a negative event are also the data objects who would benefit most from additional allocations of parameter occurrences for the particular outcome-influencing data type, but this is not always true. Further, previous techniques are unable to account for causal relationships between data types when predicting optimal numbers of parameter occurrences for multiple outcome-influencing data types. For example, previous techniques may identify an optimal number of parameter occurrences of a particular outcome-influencing data type with singular respect to a predicted effect of the particular outcome-influencing data type on a predictive outcome. Such techniques may be repeated to generate, for each of a plurality of outcome-influencing data types, an optimal number of parameter occurrences with singular respect to the predicted effect of the outcome-influencing data type. However, because the outcome-influencing data type is evaluated solely with respect to its singular predicted effect, such techniques ignore the interactions of causal effects where parameter occurrences of multiple outcome-influencing data types are allocated to a data object. Thus, the present disclosure provides improved techniques for resource allocation optimization that may lead to higher success of resource allocation operations as needed for certain data objects. In doing so, the techniques described herein improve efficiency and quality-of-service. Accordingly, the techniques described herein improve at least one of the computational efficiency, storage-wise efficiency, and operational efficiency of computational systems.

Example inventive and technologically advantageous embodiments of the present disclosure include (i) a nonlinear causal inference framework specifically configured for predicting causal effects of a plurality of outcome-influencing data types on a predictive outcome for a data object, and (ii) techniques for using the nonlinear causal inference framework to generate an optimization function configured to generate optimal parameter occurrence sets for the plurality of outcome-influencing data types, where the optimal parameter occurrence set is indicative of an optimal number of parameter occurrences for each of the plurality of outcome-influencing data types to allocate to the data object(s).

### V. EXAMPLE SYSTEM OPERATIONS

As indicated, various embodiments of the present disclosure make important technical contributions to improving allocation of parameter occurrences of multiple outcome-influencing data types. In particular, various embodiments of the present disclosure include systems and corresponding methods for determining an optimal number of parameter occurrences of two or more outcome-influencing data types to allocate to data objects based on nonlinear causal effect predictions. In doing so, the techniques described herein improve performance, e.g., resource-to-benefit, outcomes of any given computing system. Accordingly, the techniques described herein improve may be practically applied to improve the computational efficiency, storage-wise efficiency, and operational efficiency of computing system, in general, and, more specifically, predictive resource allocation computing systems.

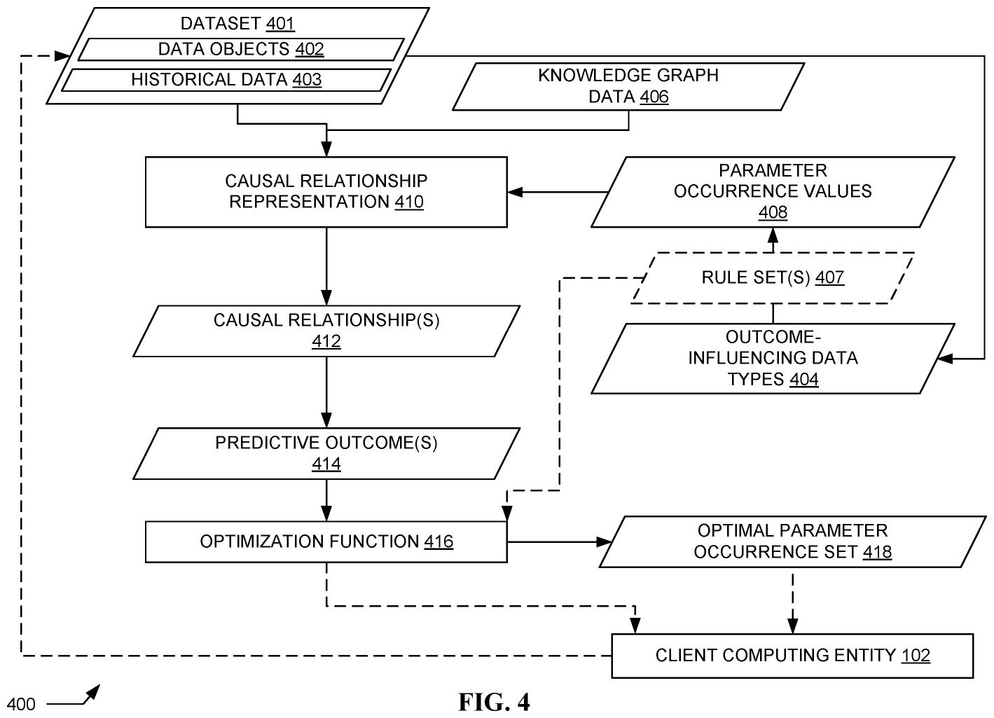

FIG. 4 provides an example dataflow diagram 400 of a technique for generating an optimal parameter occurrence set for one or more data objects in accordance with some embodiments discussed herein. In some embodiments, the technique shown in the dataflow diagram 400 is performed by a specially configured predictive data analysis system, such as the predictive data analysis system 101 shown in FIG. 1 and described herein.

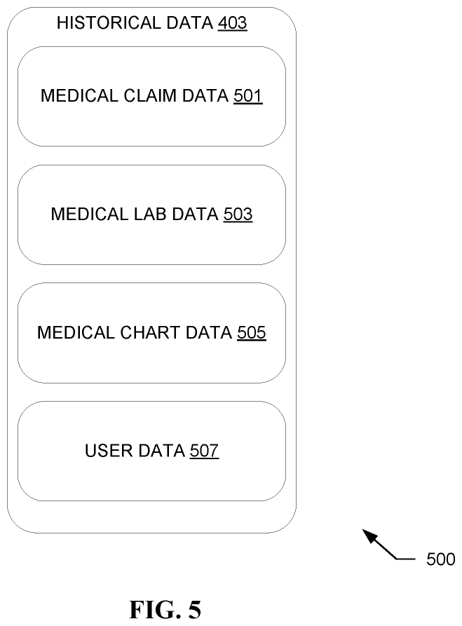

In some embodiments, a dataset 401 is received from a client computing entity 102. Alternatively, or additionally, in some embodiments, the dataset 401 is received from a data store or other memory of a predictive data analysis system. The dataset 401 may include one or more data objects 402 and historical data 403 associated with the one or more data objects 402. In one embodiment, the data object(s) 402 is/are a person or group of persons. As one example in a clinical prediction domain context, the dataset 401 includes a plurality of members of a healthcare program (data objects 402) and historical data 403 for the plurality of members including medical claims, medical lab results, medical charts and observations, and demographic data (e.g., age, gender, sex, ethnicity, and other social and/or environmental determinants of health). In some embodiments, the data objects 402 or the historical data 403 are received separately from the client computing entity 102, are obtained separately from one or more data stores of a predictive data analysis system. or are received separately from other external systems. In one example, the data objects 402 are received from a client computing entity 102 associated with a private business entity and the historical data 403 is received from one or more second client computing entities associated with an electronic record management entity. Non-limiting operational examples of historical data in a clinical prediction domain are illustrated in FIG. 5 and described herein.

In some embodiments, a plurality of outcome-influencing data types 404 is identified based on the dataset 401. For example, a plurality of types of resources that may be allocated to the data object(s) 402 may be determined based on the historical data, and potentially other data. In some embodiments, the dataset 401 includes a data construct that identifies the plurality of outcome-influencing data types 404. The plurality of outcome-influencing data types 404 may indicate different types of entity interactions between one or more parties and the data object(s) 402. As one example in a clinical prediction domain context, the plurality of outcome-influencing data types 404 may include an in-office clinical visit (e.g., first outcome-influencing data type) between a clinician (e.g., party) and a member of a healthcare program (e.g., data object) and an in-home clinical visit (e.g., second outcome-influencing data type) between a clinician and the member of the healthcare program. As another example in a clinical prediction domain context, the plurality of outcome-influencing data types 404 may include an in-office clinical visit, an in-home clinical visit, a telephonic prescription review, and a telehealth visit. In some embodiments, the one or more of the entity interactions include or are associated with one or more interaction attributes that describe or define one or more conditions, properties, or other criteria of the entity interaction.

In some embodiments, the one or more interaction attributes may include, but are not limited to, location attributes, communication mode attributes, temporal attributes, and task attributes. As one example in a clinical prediction domain context, the location attribute may include, but is not limited to, a physical location of an in-office clinical visit, a virtual location of a telehealth visit, a distance between a member location and a clinic location, and/or indication of whether the entity interaction is local to the member location, remote to the member location, or virtual. As another example in a clinical prediction domain context, the communication mode attribute may include, but is not limited to, a physical communication between a clinician and a member of a healthcare program, a virtual interaction between the clinician and the member, and/or a particular aspect or property of the virtual interaction, such as whether the virtual interaction is telephonic, video conferencing, electronical mail, virtualized reality, augmented reality, or one or more combinations thereof. As another example in a clinical prediction domain context, the temporal attribute may include a duration of a clinical visit, an initialization time for the clinical visit, a termination time for the clinical visit, a frequency for the for the clinical visit, a member or clinician travel time for the clinical visit, or one or more combinations thereof. As another example in a clinical prediction domain context, the task attribute may include a specialist to be seen by a member of a healthcare program, or a screening, assay, diagnostic process, treatment, or other action to be performed on the member during a clinical visit.

In some embodiments, parameter occurrence values 408 for each of the plurality of outcome-influencing data types 404 are determined. The parameter occurrence values 408 for each outcome-influencing data type 404 may include a possible quantity (e.g., occurrence number) of the outcome-influencing data type that may be allocated to a data object. As one example in a clinical prediction domain context, the parameter occurrence values 408 for an in-office clinical visit may include 2 visits, 3 visits, and 4 visits. In the same example, the parameter occurrence values 408 for an at-home clinical visit may include 1 visit or 2 visits. In some embodiments, the parameter occurrence values 408 include possible or permissible combinations of parameter occurrence values for each outcome-influencing data type. As one example in a clinical prediction domain context, the parameter occurrence values 408 for an in-office clinical visit (first outcome-influencing data type) and an at-home clinical visit (second outcome-influencing data type) may include 2 in-office visits and 1 at-home visits (2,1), 2 in-office visits and 2 at-home visits (2,2), 3 in-office visits and 1 at-home visits (3,1), 3 in-office visits and 2 at-home visits (3,2), 4 in-office visits and 1 at-home visits (4,1), and 4 in-office visits and 2 at-home visits (4,2). The parameter occurrence values 408 may be generated based on the historical data 403 and/or knowledge graph data 406. In some embodiments, the parameter occurrence values 408 are received from the client computing entity 102.

In some embodiments, the parameter occurrence values 408 are determined based on one or more rule sets 407 that describe, define, or otherwise configure a policy, threshold, criteria, or other constraint to a parameter occurrence value, a combination of parameter occurrence values, or a predictive outcome. As one example in a clinical prediction domain context, the rule set 407 may include a maximum number of 4 in-office clinical visits and a maximum number of 2 at-home clinical visits. The rule set 407 may define different parameter occurrence value constraints for different cohorts of data objects 402. As one example in a clinical prediction domain context, the rule set 407 may define, for a first group of healthcare program members, a maximum of 4 in-office clinical visits and a maximum 2 at-home clinical visits, and, for a second group of healthcare program members, a maximum of 3 in-office clinical visits and a maximum of 2 at-home clinical visits. In this example, when generating optimal parameter occurrence sets for each group of healthcare program members, the nonlinear causal inference framework may use the corresponding set of parameter occurrence values.

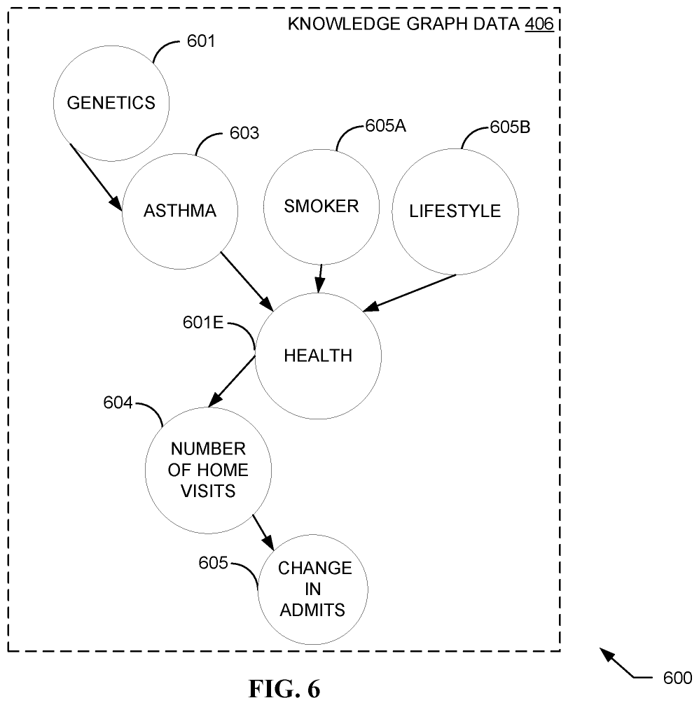

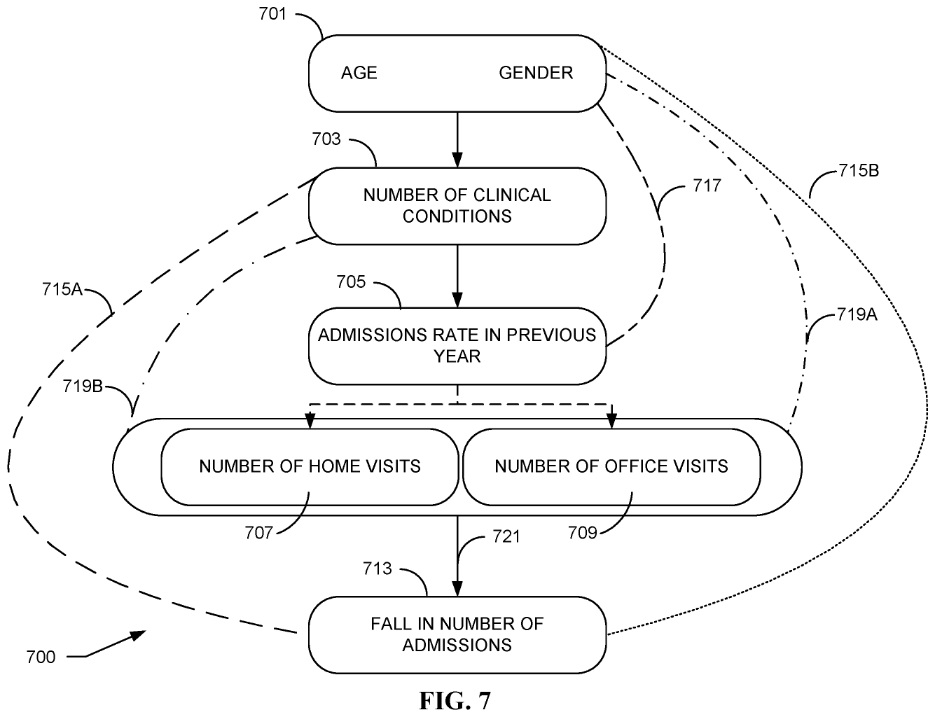

In some embodiments, a causal relationship representation 410 is generated based on the dataset 401 and the parameter occurrence values. In some embodiments, the causal relationship representation 410 is generated further based on knowledge graph data 406. In one example, a non-parametric double/debiased machine learning model (causal relationship representation 410) is generated based on the historical data 403, the parameter occurrence values 408, and the knowledge graph data 406. In some embodiments, the knowledge graph data 406 includes one or more directed acyclic graphs. As one example in a clinical prediction domain context, the knowledge graph data 406 includes a causal diagram including one or more assumptions about the directionality, monotonicity, and/or other relationships between causal variables, such as age, gender, number of clinical conditions, hospital admission rates, number of home visits, and number of in-office visits, and between one or more of the causal benefits and a causal effect (e.g., predictive outcome), such as a fall in a number of hospital admissions or a cost of hospital admissions. In some embodiments, the knowledge graph data 406 is obtained from one or more data stores of a predictive data analysis system and/or received from one or more client computing entities 102. Non-limiting operational examples of knowledge graph data in a clinical prediction domain are illustrated in FIGS. 6 and 7 and described herein.

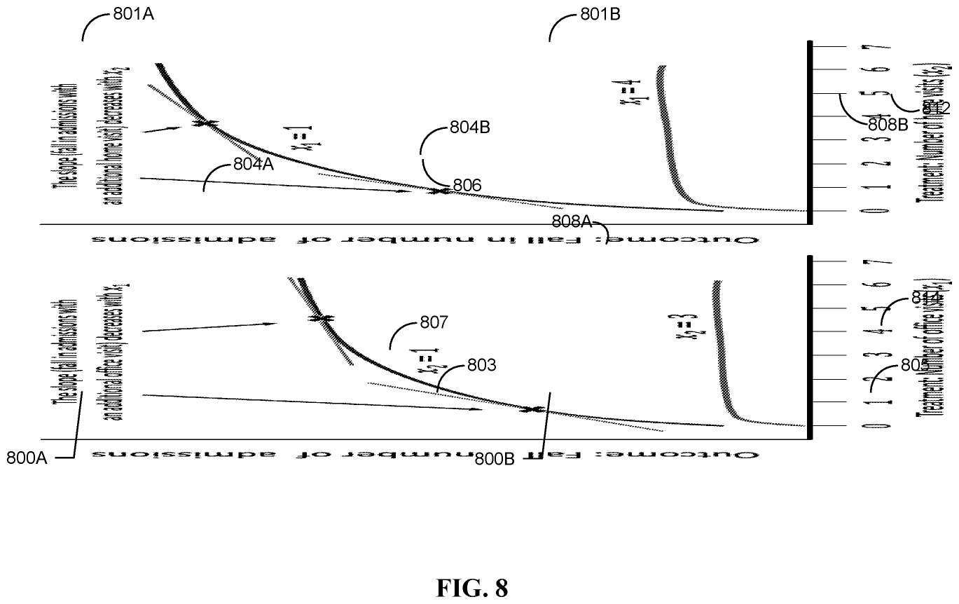

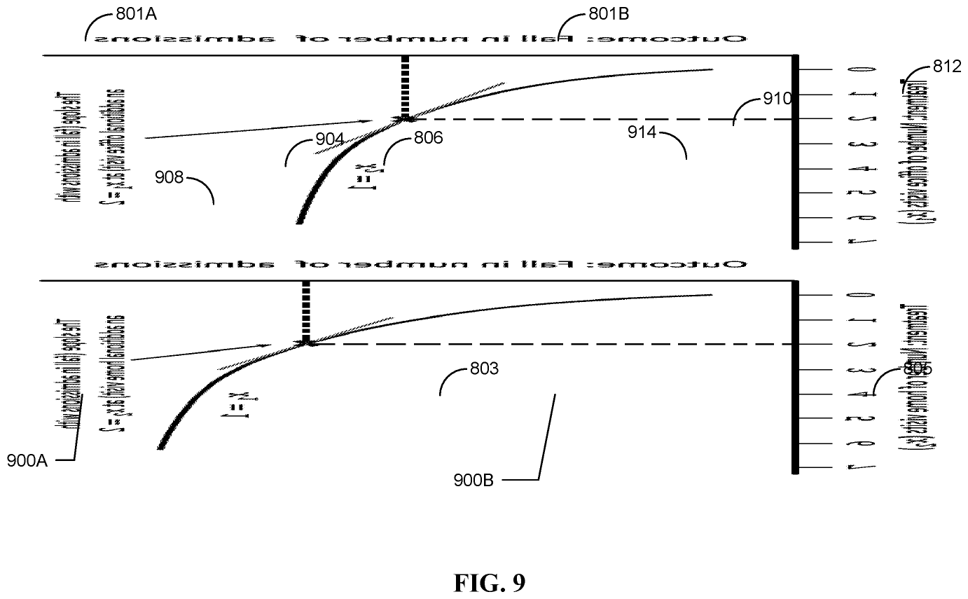

In some embodiments, the causal relationship representation 110 includes a model, such as a machine learning model, configured to compute a causal effect value for each parameter occurrence value 408 of each of the plurality of outcome-influencing data types 404. Non-limiting operational examples of causal relationships generated by a causal relationship representation in a clinical prediction domain are illustrated in FIGS. 8 and 9 and described herein.

In some embodiments, one or more causal relationships 412 are generated using the causal relationship representation 410. For example, the causal relationship representation 410 and supervised machine learning regression techniques may be used to compute a causal relationship 412 for each set of parameter occurrence values 408 of each outcome-influencing data type 404. The causal relationships 412 may indicate a causal effect value respective to a predictive outcome for each parameter occurrence value 408 of each outcome-influencing data type 404. As one example in a clinical prediction domain context, the predictive outcome may be number of hospital admissions. In this example, a causal relationship between quantity of in-office clinical visits and a fall in the number of hospital admissions (causal effect value) may be generated, and a second causal relationship between quantity of at-home clinical visits and a fall in the number of hospital admissions may be generated.

In some embodiments, a predictive outcome 414, or change to a predictive outcome (e.g., causal effect), is generated for each combination of parameter occurrence values 408 for the plurality of outcome-influencing data types 404. In some embodiments, for each combination of parameter occurrence values 408, the predictive outcome 414, or causal effect, is generated with respect to each outcome-influencing data type as influenced by the other outcome-influencing data types being evaluated. As one example in a clinical prediction domain context, for each combination of number of in-office clinical visits and number of at-home clinical visits, a first predictive outcome is generated with respect to the in-office visit data type as influenced by the at-home visit data type, and a second predictive outcome is generated with respect to the at-home visit data type as influenced by the in-office data type.

In some embodiments, to generate the predictive outcomes 414 or causal effects, a predictive outcome function is generated for a baseline combination of parameter occurrence values 408, such as, for example, a combination of the minimum parameter occurrence values for each outcome-influencing data type. Equation 1 shows an example predictive outcome function F in a clinical prediction domain context where variable x₁ may refer to a number of in-office clinical visits allocated to members of a healthcare program, x₂ may refer to a number of at-home visits allocated to the members, and A may refer to a total number of hospital admissions of the members (e.g., all of which may correspond to a particular interval, such as 1 year, 2 years, 6 months, or any suitable interval value). In this example, the baseline combination of parameter occurrence values may be 2 in-office clinical visits and 1 at-home clinical visit (e.g., x₁=2 and x₂=1).

$$F = F ( {x}_{1} , {x}_{2} , A ) \qquad ( Equation 1 )$$

In some embodiments, to generate the predictive outcome 414, or causal effect, with respect to each outcome-influencing data type as influenced by the other outcome-influencing data types being evaluated, a derivation function of the predictive outcome function is generated respective to each outcome-influencing data type. The derivative functions may be taken with respect to a change in the number of parameter occurrences of each outcome-influencing data type and a rate of change in the predictive outcome 414, or causal effect. In some embodiments, the value of the derivative function for a given parameter occurrence combination is referred to as a predictive value for the parameter occurrence combination. Equations 2 and 3 show example derivative functions in a clinical prediction domain context where G₁ may refer to a change in a number of in-office clinical visits allocated to members of a healthcare group and G₂ may refer to a change in a number of at-home clinical visits allocated to the members.

$$\frac{d F}{d {x}_{1}} = {G}_{1} ( {x}_{1} , {x}_{2} , \frac{d A}{d {x}_{1}} ) = {G}_{1} ( {x}_{1} , {x}_{2} ) \qquad ( Equation 2 )$$

$$\frac{d F}{d {x}_{2}} = {G}_{2} ( {x}_{1} , {x}_{2} , \frac{d A}{d {x}_{2}} ) = {G}_{2} ( {x}_{1} , {x}_{2} ) \qquad ( Equation 3 )$$

In some embodiments, the rate of change of the predictive outcome 414, or causal effect, is estimated using the causal relationship representation 410 and/or causal relationships 412 generated thereby. As described, the causal relationships 412 may indicate changes to a predictive outcome (e.g., causal effects) for parameter occurrence values of an outcome-influencing data type. In one example, each causal relationship 412 for each outcome-influencing data type 404 may include a nonlinear causal inference curve. In this example, a rate of change for the predictive outcome 414, or causal effect, for each outcome-influencing data type 404 may be estimated using the slope of the nonlinear inference curve at a point on the nonlinear inference curve corresponding to each parameter occurrence value 408 for the outcome-influencing data type 404.

In some embodiments, the predictive outcomes 414 are generated using the predictive outcome function and each derivation function. The baseline combination of parameter occurrence values 408 may be used to generate a baseline value of the predictive outcome 414. The predictive outcome 414 for each of the additional combinations of parameter occurrence values 408 may be outputted explicitly or as a delta or other comparison expression taken with respect to the baseline value of the predictive outcome 414. Table 1 shows an example, in a clinical prediction domain context, of a baseline predictive outcome and predictive outcomes 414 for each combination of parameter occurrence values 408 for the plurality of outcome-influencing data types 404. In Table 1, f may correspond to the value of the baseline predictive outcome and subsequent entries in the same column may correspond to the predictive outcomes for the additional combinations of parameter occurrence values.

TABLE 1
Example Predictive Outcomes

| (x₁, x₂) | $\frac{dF ( {x}_{1} , {x}_{2} )}{{dx}_{1}}$ | $\frac{dF ( {x}_{1} , {x}_{2} )}{{dx}_{2}}$ | F(x₁, x₂) |
|---|---|---|---|
| (2, 1) | −1.5 | −1.29 | f |
| (2, 2) | −1.22 | −1.44 | f − 1.29 |
| (3, 1) | −1.43 | −1.05 | f − 1.5 |
| (3, 2) | −1.19 | −0.87 | f − 2.55 |
| (4, 1) | −1.22 | −0.81 | f − 2.93 |
| (4, 2) | −1.08 | −0.73 | f − 3.74 |

In some embodiments, the predictive outcomes 414 are generated in an incremental flow in which, to progress through numerically adjacent parameter occurrence values, preceding derivative function values are used to map out the hyperparameter space of all values of the predictive outcome 414 for the combinations of parameter occurrence values 408. For example, in Table 1, an incremental step from x₂=1 to x₂=2 and the derivative function values for

$$\frac{d F ( {x}_{1} , {x}_{2} )}{d {x}_{1}} and \frac{d F ( {x}_{1} , {x}_{2} )}{d {x}_{2}} ( {x}_{1} = 2 , {x}_{2} = 1 )$$

may be used to compute the derivative function values for the combination of x₁=2 and x₂=2. In some embodiments, for instances where more than one incremental pathway between parameter occurrence combinations is available, a weighted or unweighted average of the derivative values associated with each pathway is used.

For example, in Table 1, two incremental pathways may be available for incrementing to the combination of x₁=3 and x₂=2 (e.g., incrementing from the combination of (3, 1) to (3, 2) or from (2, 2) to (3, 2)). In this example, for the derivative function of each outcome-influencing data type, a first derivative function value may be generated for the first pathway (e.g., incrementing (3, 1) to (3, 2)) and a second derivative function value may be generated for the second pathway (e.g., from (2, 2) to (3, 2)). Continuing the example, for the derivative function of each outcome-influencing data type, an aggregate derivative value may be generated based on an average of the first derivative function value associated with the first pathway and the second derivative function value associated with the second pathway. In some embodiments, in instances where any value of a derivative function is cannot be generated (e.g., due to data quality issues, missing data values, etc.) one or more regression techniques are used to interpolate or extrapolate the missing derivative value(s). For example, a Gaussian process regression may be used to interpolate or extrapolate an estimate for a missing derivative value.

In some embodiments, an optimization function 416 is generated based on one or more of the causal relationship representations 410, the causal relationships 412, the predictive outcomes 414, and the one or more rule sets 407. In some embodiments, the optimization function 416 is configured to generate one or more optimal parameter occurrence sets 418 for the one or more data objects 402. The optimization function 416 may be configured to generate the optimal parameter occurrence set(s) 418 based on the predictive outcomes 414. The optimization function 416 may be configured to determine the combination of parameter occurrence values 408 that best meets one or more thresholds, constraints, or other criteria associated with the predictive outcomes 414. For example, the optimization function 416 may be configured to determine the combination of parameter occurrence values 408 that minimizes a value of the predictive outcomes 414 or maximizes a rate of change of the value of the predictive outcome 414. In some embodiments, the optimization function 416 is provided to one or more client computing entities 102.

As one example in a clinical prediction domain context, the optimization function 416 may be configured to determine which of the parameter occurrence values shown in Table 1 (e.g., x₁, x₂) is associated with the lowest value for the predictive outcome function F(x₁, x₂) or, in other words, the greatest delta in the value for the predictive outcome function relative to the baseline value (e.g., x₁=2, x₂=1). Continuing the example, the optimization function 416 may determine the optimal parameter occurrence set for allocating in-office clinical visits and at-home clinical visits to the members of the healthcare program to be 4 in-office clinical visits and 2 at-home visits (e.g., x₁=4, x₂=2). In this example, the optimal parameter occurrence set of (4, 2) may be a combination of parameter occurrence values that is predicted to minimize the number of hospital admissions of the members of the healthcare program and/or predicted to minimize the overall cost of the healthcare program.

In some embodiments, the rule set 407 includes one or more thresholds, constraints, or other criteria based on which the optimization function 416 generates the optimal parameter occurrence set 418. For example, the rule set 407 may include a minimum, maximum, or other threshold value for a predictive cost of providing parameter occurrences of the plurality of outcome-influencing data types 404 to the data object(s) 402. In this example, the minimum value for the predictive cost may result in the optimization function 416 being configured to generate an optimal parameter occurrence set 418 that includes a combination of parameter occurrence values 408 associated with a lowest value predictive outcome (e.g., the predictive outcomes 414 being indicative of the predictive cost). As another example, the rule set 407 may include a maximum value for a resource utilization metric (e.g., the predictive outcomes 414 being indicative of a quantity of resources that would be utilized for each combination of parameter occurrence values 408). In this example, the maximum value for the resource utilization metric may result in the optimization function being configured to generate an optimal parameter occurrence set 418 that includes a combination of parameter occurrence values 408 associated with a resource utilization quantity that is less than the maximum value for the resource utilization metric and/or associated with the greatest negative delta from the maximum value for the resource utilization metric.

In some embodiments, the optimal parameter occurrence set 418 is generated using the optimization function 416 and the values of the predictive outcome(s) 414. The optimal parameter occurrence set 418 may be indicative of an optimal number of parameter occurrences for each of the plurality of outcome-influencing data types 404. As one example in a clinical prediction domain context, the optimal parameter occurrence set 418 may indicate an optimal number of in-office clinical visits, at-home clinical visits, prescription review sessions, and telehealth visits to allocate to members of a healthcare program such that (1) a predicted number of hospital admissions of the members is minimized and/or (2) a predicted cost of the healthcare program is minimized.

FIG. 5 provides an example architecture 500 of historical data in a clinical prediction domain in accordance with some embodiments discussed herein. In some embodiments, in a clinical prediction domain context, a plurality of data objects may include a plurality of human subjects. In some embodiments, in a clinical prediction domain context, the historical data 403 includes, for each human subject, medical claim data 501, medical lab data 503, medical chart data 505, and user data 507. In some embodiments, medical claim data 501 includes data constructs describing one or more medical conditions of the human subject, or a hereditary associate or partner thereof, and information related to the medical condition(s). For example, the medical claim data 501 may include one or more of, but is not limited to, diagnoses (e.g., asthma, high blood pressure, diabetes, etc.), prognoses, treatment plans, procedures, and medication prescriptions.

In some embodiments, medical lab data 503 includes data constructs describing lab tests performed on a human subject and results thereof. For example, the medical lab data may include one or more of, but is not limited to, glucose test results, body-mass indexes, cholesterol levels, respiration rates, blood pressure measures, medical imaging data (e.g., data associated with X-ray, echocardiography, magnetic resonance imaging, radiation imaging, computed tomography, positive emission tomography, or other medical imaging techniques), electrocardiogram records, and electroencephalogram records.

In some embodiments, medical chart data 505 includes data constructs describing observations and conversations associated with the human subject, which may correspond to natural language data. For example, the medical chart data 505 may include one or more of, but is not limited, to subject responses to pain inquiries, observations of subject fatigue, observations of subject mental acuity or deficiency, and observations of subject speech or other physiological functions or behaviors (e.g., gait, memory, diet, mental state, etc.).

In some embodiments, user data 507 includes data constructs describing demographics and other non-medical information associated with a human subject. For example, the user data 507 may include one or more of, but is not limited to, age, gender, sex, ethnicity, smoker status, drinker status, other substance usage statuses, social and/or environmental determinants of health (e.g., income, social protection, education, employment history, working conditions, food security, housing security, amenity access, childhood development history, and medical care access).

FIG. 6 provides an example architecture 600 of knowledge graph data in a clinical prediction domain in accordance with some embodiments discussed herein. In some embodiments, the knowledge graph data 406 defines directed relationships between a plurality of nonlinear causal inferencing factors including confounders, outcome-influencing data type variables (e.g., or other causal variables), and predictive outcomes. In some embodiments, the confounders include historical data associated with one or more data objects. In one example, as shown in the example architecture 600, the knowledge graph data 406 may include one or more genetic confounders 601, one or more medical condition confounders 603, one or more behavioral confounders, such as a smoking confounder 605A and/or a lifestyle confounder 605B, and one or more health confounders 601E. Continuing the example, as shown in the example architecture 600, the knowledge graph data 406 may include one or more outcome-influencing data type variables 604, such as a number of at-home clinical visits or a number of in-office clinical visits. In the same example, as shown in the example architecture 600, the knowledge graph data 406 may include a predictive outcome 605, such as a change in a number of hospital admissions or a cost of providing a healthcare program. In some embodiments, the directed relationships between nonlinear causal inferencing factors are generated by a team of experts in the relevant domain(s), by one or more machine learning models, by one or more statistical analysis, or by one or more combinations thereof.

FIG. 7 provides an operational example of a directed acyclic graph 700 in a clinical prediction domain in accordance with some embodiments discussed herein. As described herein, in some embodiments, knowledge graph data includes one or more directed acyclic graphs.

In some embodiments, the directed acyclic graph 700 is a causal diagram that contains assumptions about how the interrelated and directed relationships of nonlinear causal inferencing factors. For example, the directed acyclic graph 700 may define interactions 715A, 715B, 717, 719A, 719B between directed relationships among confounders 701, 703, 705, outcome-influencing data types 707, 709, and a predictive outcome 713. In this example, the directed acyclic graph 700 may define prior assumptions around: (i) interactions 715A between clinical condition confounders 703 and the predictive outcome 713 (e.g., fall in number of admissions); (ii) interactions 715B between age and/or gender confounders 701 and the predictive outcome 713; (iii) interactions 717 between the age and/or gender confounders 701 and a prior admission rate confounder 705; (iv) interactions 719A between the age and/or gender confounder 701 and one or more outcome-influencing data types, such as number of at-home clinical visits (e.g., outcome-influencing data type 707) or number of in-office clinical visits (e.g., outcome-influencing data type 709); (v) interactions 719B between the number of clinical condition confounders 703 and the predictive outcome 713; and (vi) interactions 721 between one or more outcome-influencing data types and the predictive outcome 713.

FIG. 8 provides operational examples of causal relationship representations 800A, 800B in a clinical prediction domain in accordance with some embodiments discussed herein. In some embodiments, the causal relationship representations 800A, 800B are generated using a machine learning model, such as a non-parametric double/debiased machine learning model leveraging supervised machine learning regression techniques.

In some embodiments, the causal relationship representations 800A, 800B indicate relationships between parameter occurrence values of a first outcome-influencing data type 803 (e.g., x₁, a number of in-office clinical visits) and a second outcome-influencing data type 805 (e.g., x₂, a number of in-home clinical visits) and changes in a predictive outcome 801A, 801B (e.g., fall in a number of hospital admissions).

In some embodiments, the causal relationship representation 800A indicates a relationship between a number of parameter occurrences of the first outcome-influencing data type 803 (e.g., number of in-office clinical visits) and the predictive outcome 801A, 801B (e.g., fall in a number of hospital admissions) given a particular value for a number of parameter occurrences for the second outcome-influencing data type 805 (e.g., 1 at-home clinical visit or 3 at-home clinical visits). In some embodiments, the causal relationship representation 800A includes nonlinear causal inference curve 806 and nonlinear causal inference curve 807. In one example, the nonlinear causal inference curve 806 indicates a relationship between a number of in-office clinical visits allocated to members of a healthcare program and a fall in admissions when the members are also allocated 1 at-home clinical visit. In another example, the nonlinear causal inference curve 807 indicates a relationship between a number of in-office clinical visits allocated to the members of the healthcare program and a fall in admissions when the members are also allocated 3 at-home clinical visits.

In some embodiments, the causal relationship representation 800B indicates a relationship between a number of parameter occurrences of the second outcome-influencing data type 805 (e.g., number of at-home clinical visits) and the predictive outcome 801A, 801B (e.g., fall in a number of hospital admissions) given a particular value for a number of parameter occurrences for the first outcome-influencing data type 803 (e.g., 1 in-office clinical visit or 4 in-office clinical visits). In some embodiments, the causal relationship representation 800B includes nonlinear causal inference curves 812 and nonlinear causal inference curve 814. In one example, the nonlinear causal inference curve 812 indicates a relationship between a number of at-home clinical visits allocated to the members of a healthcare program and a fall in admissions when the members are also allocated 1 in-office clinical visit. In another example, the nonlinear causal inference curve 814 indicates a relationship between a number of at-home clinical visits allocated to the members of the healthcare program and a fall in admissions when the members are also allocated 4 in-office clinical visits.

As described herein, the slopes of the nonlinear causal inference curves may be used to generate derivative function values for predicting an overall predictive function value for all possible combinations of parameter occurrence values for a plurality of outcome-influencing data types, where the overall predictive function value indicates a predictive outcome, or change therein, for one or more data objects. For example, in a clinical prediction domain context, the slopes of the nonlinear causal inference curve 806 and the nonlinear causal inference curve 807 may be used to generate a value for the predicted fall in number of admissions when members of a healthcare group are allocated, explicitly or additionally, between 0 and 7 in-office clinical visits and 1 or 3 in-home clinical visits. In the same example, the slopes of the nonlinear causal inference curve 812 and nonlinear causal inference curve 814 may be used to generate a value for the predicted fall in number of admissions when the members are allocated, explicitly or additionally, between 0 and 7 at-home clinical visits and 1 or 4 in-office clinical visits.

FIG. 9 provides operational examples of causal relationships 900A, 900B generated by a causal relationship representation in a clinical prediction domain in accordance with some embodiments discussed herein. In some embodiments, the causal relationship 900A includes the nonlinear causal inference curve 806 that indicates a relationship between a number of parameter occurrences of the first outcome-influencing data type 803 (e.g., number of in-office clinical visits) and the predictive outcome 801A, 801B (e.g., fall in a number of hospital admissions) given a particular value for a number of parameter occurrences for the second outcome-influencing data type 805 (e.g., 1 at-home clinical visit). For example, for a particular number of parameter occurrences 908, a slope 904 of the nonlinear causal inference curve 806 may indicate a value of the predictive outcome 801A, 801B. As one example in a clinical prediction domain context, the nonlinear causal inference curve 806 may indicate a predicted fall in admissions when members of a healthcare program are allocated 2 in-office visits (e.g., explicitly or in addition to a currently allocated number of in-office visits).

In some embodiments, the causal relationship 900B includes the nonlinear causal inference curve 812 that indicates a relationship between a number of parameter occurrences of the second outcome-influencing data type 805 (e.g., number of at-home clinical visits) and the predictive outcome 801A, 801B given a particular value for number of parameter occurrences for the first outcome-influencing data type 803 (e.g., 1 in-office clinical visit). For example, for a particular number of parameter occurrences 914, a slope 910 of the nonlinear causal inference curve 812 may indicate a value of the predictive outcome 801A, 801B. As one example in a clinical prediction domain context, the nonlinear causal inference curve 812 may indicate a predicted fall in admissions when members of a healthcare program are allocated 2 at-home visits (e.g., explicitly or in addition to a currently allocated number of at-home visits).

As described herein, the slopes of the nonlinear causal inference curves may be used to generate values for predicting an overall causal effect of a combination of parameter occurrence values for a plurality of outcome-influencing data types on a predictive outcome for one or more data objects. For example, in a clinical prediction domain context, the slopes may be used, as described herein, to generate a value for the predicted fall in number of admissions when members of a healthcare group are allocated, explicitly or additionally, 2 in-office clinical visits and 1 at-home visit, 1 in-office clinical visit and 2 at-home clinical visits, or 2 in-office clinical visits and 2 at-home clinical visits.

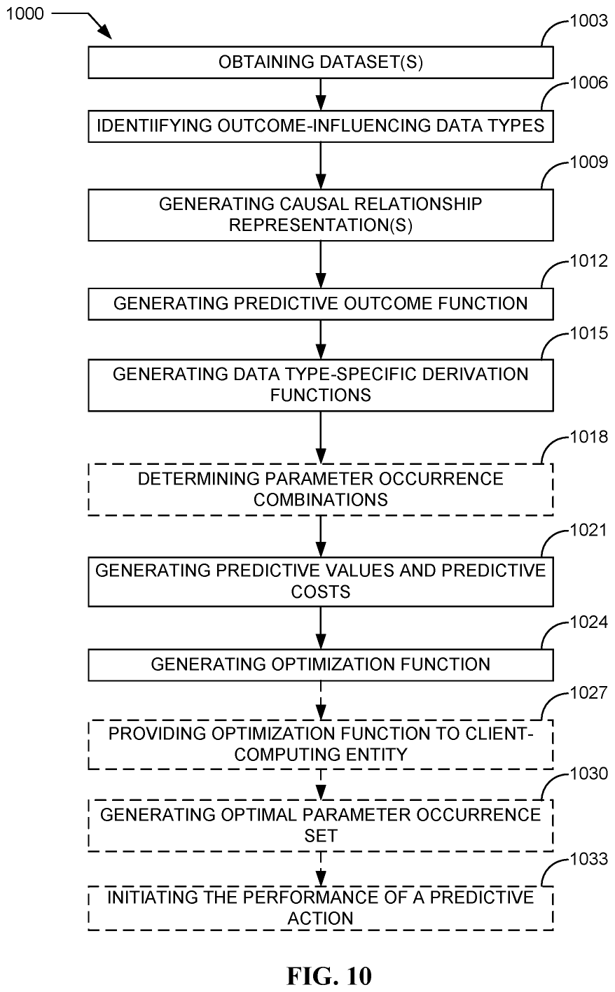

FIG. 10 is a flowchart diagram of an example process 1000 for determining optimal parameter occurrence sets for one or more data objects in accordance with some embodiments described herein. The flowchart depicts nonlinear causal inference techniques for generating an optimal parameter occurrence set associated with two or more outcome-influencing data types to overcome various limitations of traditional resource allocation. The nonlinear causal inference techniques may be implemented by one or more computing devices, entities, and/or systems described herein. For example, via the various steps/operations of the process 1000, the predictive data analysis system 101 may leverage the nonlinear causal inference techniques to overcome the various limitations with traditional techniques by using nonlinear causal inference models and an optimization function to estimate interactive causal effects of various parameter occurrence combinations of a plurality of outcome-influencing data types on a predictive outcome.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, some of the steps/operations depicted may be omitted or combined in a manner that does not materially impact the function of the process 1000. In other examples, different components of an example device or system that implements the process 1000 may perform functions at substantially the same time or in a specific sequence.

In some embodiments, the process 1000 includes, at step/operation 1003, obtaining one or more datasets. For example, the predictive data analysis system 101 may obtain the one or more datasets. In some embodiments, the dataset(s) are received from one or more client computing entities. For example, the predictive data analysis system 101 may receive the dataset(s) from one or more client computing entities, such as a client computing entity 102. In some embodiments, the dataset includes one or more data objects. In some embodiments, the dataset includes historical data for the one or more data objects. In some embodiments, the dataset includes knowledge graph data associated with the historical data and/or data types thereof. In some embodiments, the dataset includes a plurality of outcome-influencing data types. In some embodiments, the dataset includes a historical predictive outcome and/or a historical predictive cost thereof. In some embodiments, the dataset includes a rule set. In some embodiments, one or more of knowledge graph data, a rule set, and historical data are obtained from a data store or other memory. For example, the predictive data analysis system 101 may obtain one or more of knowledge graph data, a rule set, and historical data from a data store or other memory.

In some embodiments, the process 1000 includes, at step/operation 1006, identifying a plurality of outcome-influencing data types. For example, the predictive data analysis system 101 may identify the plurality of outcome-influencing data types. In some embodiments, a plurality of outcome-influencing data types for a dataset including one or more data objects are identified. For example, the predictive data analysis system 101 may identify a plurality of outcome-influencing data types for a dataset including one or more data objects, where each of the plurality of data objects is associated with a number of parameter occurrences for each of the plurality of outcome-influencing data types (e.g., which may be described in or otherwise identifiable from the historical data). In some embodiments, the plurality of outcome-influencing data types is indicative of a plurality of different types of entity interactions between a party and the one or more data objects. In some embodiments, each of the plurality of different types of entity interactions are associated with one or more interaction attributes. For example, the interaction attributes may include one or more location attributes, one or more temporal attributes, one or more task attributes, and/or one or more communication mode attributes. In a particular example, the interaction attribute may include a location attribute that indicates whether an entity interaction is associated with a remote location, a local location, or a virtual location.

In some embodiments, the step/operation 1006 includes filtering a plurality of data objects to generate one or more subsets of data objects based on historical data, such as a particular historical combination of parameter occurrences allocated to a data object for a historical interval (e.g., within 1 year, within 2 years, within 6 months, or any suitable interval value). In some embodiments, the plurality of data objects is filtered based on the historical data. For example, the predictive data analysis system 101 may filter the plurality of data objects to generate the subset of data objects based on the historical data. As one example in a clinical predictive domain context, the predictive data analysis system 101 may filter a plurality of members of a healthcare program to generate a first subset of members that had 3 at-home clinical visits per year, a second subset of members that had 4 at-home clinical visits per year. In the same example, the predictive data analysis system 101 may filter the plurality of members, and/or the first or second subsets, to generate a third subset of members that had 1 in-office clinical visits per year and 3 at-home clinical visits per year and a fourth subset of members that had 2 in-office clinical visits per year and 4 at-home clinical visits per year.

In some embodiments, the process 1000 includes, at step/operation 1009, generating one or more causal relationship representations. For example, the predictive data analysis system 101 may generate the one or more causal relationship representations. In some embodiments, the causal relationship representation is generated based on the dataset. For example, the predictive data analysis system 101 may generate the causal relationship representation based on the dataset. In some embodiments, the causal relationship representation is indicative of a causal relationship between each of the plurality of outcome-influencing data types and a predictive outcome of the one or more data objects from the data set. For example, the causal relationship representation may indicate a causal relationship between a predictive outcome and all possible parameter occurrence values for each the plurality of outcome-influencing data types while parameter occurrence values for other outcome-influencing data types are held constant.

In some embodiments, the causal relationship representation is generated using a non-parametric machine learning model and based on the dataset and knowledge graph data that indicates one or more relationships between the plurality of outcome-influencing data types and the predictive outcome. For example, the predictive data analysis system 101 may generate the causal relationship representation using a non-parametric machine learning model. In one example, the non-parametric machine learning model may be a double machine learning model or a double/debiased machine learning model. In some embodiments, the knowledge graph data includes a directed acyclic graph.

In some embodiments, the process 1000 includes, at step/operation 1012, generating a predictive outcome function. For example, the predictive data analysis system 101 may generate the predictive outcome function. In some embodiments, the predictive outcome function is generated based on a baseline combination of parameter occurrence values for the plurality of outcome-influencing data types. For example, the predictive data analysis system 101 may generate the predictive outcome function based on a baseline combination of parameter occurrence values. In a particular example, the predictive data analysis system 101 may generate the predictive outcome function based on a predictive outcome associated with a combination of the minimum parameter occurrence values for each outcome-influencing data type.

In some embodiments, the process 1000 includes, at step/operation 1015, generating data type-specific derivation functions. For example, the predictive data analysis system 101 may generate the data type-specific derivation functions. In some embodiments, the data-type specific data functions correspond to or include causal relationships, from the causal relationship representation, between each of the plurality of outcome-influencing data types and the predictive outcome. In some embodiments, the data-type specific derivation functions are derivative functions of the predictive outcome functions. In some embodiments, each derivative function is taken with respect to a change in the number of parameter occurrences of each outcome-influencing data type and a rate of change in the predictive outcome, or predictive cost thereof. In one example, the predictive data analysis system 101 may generate a plurality of data type-specific derivation functions, where each data-type specific derivation function is taken with respect to one of the plurality of outcome-influencing data types and describes a rate of change in the predictive outcome for a range of parameter occurrence values of the outcome-influencing data type while parameter occurrences of other outcome-influencing types are configured to fixed values.

In some embodiments, the process 1000 includes, at step/operation 1018, determining a plurality of parameter occurrence combinations for the plurality of outcome-influencing data types. For example, the predictive data analysis system 101 may determine the plurality of parameter occurrence combinations for the plurality of outcome-influencing data types. In some embodiments, the plurality of parameter occurrence combinations includes all possible combinations of all possible parameter occurrence values for each of the plurality of outcome-influencing data types. In some embodiments, each parameter occurrence combination includes a combination of parameter occurrence values for the plurality of outcome-influencing data types. In some embodiments, the predictive data analysis system 101 determines that plurality of parameter occurrence combinations based on one or more rule sets.

In some embodiments, the process 1000 includes, at step/operation 1021, generating predictive values and predictive costs. For example, the predictive data analysis system 101 may generate the predictive values and predictive costs. In some embodiments, the predictive cost is a causal effect of a particular combination of parameter occurrence values for the plurality of outcome-influencing data types on the predictive outcome, or predictive cost thereof. In some embodiments, the predictive values are derivative values generated using each data type-specific derivative function and the parameter occurrence values of a parameter occurrence combination. In one or more embodiments, the predictive cost for each parameter occurrence combination is generated using the predictive outcome function and the predictive values for the parameter occurrence combination. For example, the predictive data analysis system 101 may generate the predictive cost for each parameter occurrence combination using the predictive outcome function and the predictive values for the parameter occurrence combination as generated using the data type-specific derivative functions.

In some embodiments, the predictive cost is based on data type-specific derivation values associated with a particular parameter occurrence combination. In a particular example, the predictive data analysis system 101 may generate, using a first data type-specific derivative function, a first predictive value for a respective parameter occurrence combination, where the first predictive value may indicate a predicted effect of the respective parameter occurrence combination on the predictive outcome with respect to a first outcome-influencing data type of the plurality of outcome-influencing data types. In the same example, the predictive data analysis system 101 may generate, using a second data type-specific derivative function, a second predictive value for the respective parameter occurrence combination, where the second predictive value may indicate a predicted effect of the respective parameter occurrence combination on the predictive outcome with respect to a second outcome-influencing data type of the plurality of outcome-influencing data types. Continuing the example, the predictive data analysis system may generate a predictive cost for the respective parameter occurrence combination of the plurality of parameter occurrence combinations based on the first predictive value and the second predictive value.

In some embodiments, predictive values are generated in an incremental flow in which, to progress through numerically adjacent parameter occurrence values, preceding derivative function values are used to map out the hyperparameter space of all values of the predictive costs for the combinations of parameter occurrence values. In some embodiments, where more than one incremental pathway between parameter occurrence combinations is available, a weighted or unweighted average of the derivative values associated with each pathway is used. For example, two incremental pathways may be available for incrementing to a particular combination of parameter occurrence values (e.g., incrementing from a first preceding combination of parameter occurrence values or from a second preceding combination of parameter occurrence values. In this example, for the derivative function of each outcome-influencing data type, the predictive data analysis system 101 may generate a first derivative function value may be generated for the first pathway (e.g., incrementing from the first preceding combination of parameter occurrence values to the particular combination of parameter occurrence values) and generate a second derivative function value for the second pathway (e.g., from (e.g., incrementing from the first preceding combination of parameter occurrence values to the particular combination of parameter occurrence values). Continuing the example, for the derivative function of each outcome-influencing data type, the predictive data analysis system 101 may generate an aggregate derivative value based on an average of the first derivative function value associated with the first pathway and the second derivative function value associated with the second pathway. In some embodiments, in instances where any value of a derivative function cannot be generated (e.g., due to data quality issues, missing data values, etc.) one or more regression techniques are used to interpolate or extrapolate the missing derivative value(s). For example, the predictive data analysis system 101 may use a Gaussian process regression to interpolate or extrapolate an estimate for a missing derivative value.

In some embodiments, the process 1000 includes, at step/operation 1024, generating an optimization function. For example, the predictive data analysis system 101 may generate the optimization function. In a particular example, the predictive data analysis system 101 generates the optimization function using the causal relationship representation, including predictive values and/or predictive costs generated therefrom. In some embodiments, the optimization function includes the predictive outcome function and the data type-specific derivation functions.

In some embodiments, the optimization function is an estimation function for identifying an optimal parameter occurrence set, which may be a parameter occurrence combination for which the nonlinear causal effect to the predictive outcome, or predictive cost thereof, satisfies a particular threshold, rule, or other criteria (e.g., minimizing the predictive outcome, maximizing the predictive outcome, etc.). For example, the optimization function may be configured to generate the optimal parameter occurrence set based on the predictive costs of the plurality of parameter occurrence combinations. In some embodiments, the optimization function is configured to generate a ranking of the plurality of parameter occurrence combinations based on the predictive cost associated with each parameter occurrence combination. In some embodiments, the optimization function is configured to generate the optimal parameter occurrence set based on a top-ranked entry of the occurrence combination ranking, which may indicate one of the plurality of parameter occurrence combinations that best satisfies a threshold, rule, or other criteria for the predictive outcome.

In some embodiments, the optimization function may be generated based on one or more rule sets. For example, the predictive data analysis system 101 may generate the optimization function based on a rule set that indicates a target threshold for the predictive outcome, or predictive cost thereof. In this example, the target threshold may indicate that the optimal parameter occurrence combination may be the parameter occurrence combination that minimizes a predictive cost for the predictive outcome. In a clinical predictive domain context, the target threshold may indicate that the optimal parameter occurrence combination may be a combination of healthcare program benefit allocations of various types that minimizes a resource utilization metric for the healthcare program and/or minimizes a predictive cost for providing the benefit allocations of the healthcare program.

In some embodiments, the process 1000 includes, at step/operation 1027, providing the optimization function to one or more client computing entities. For example, the predictive data analysis system 101 may provide the optimization function to one or more client computing entities 102. In some embodiments, the optimization function and the parameter occurrence combinations of the plurality of outcome-influencing data types are provided to one or more client computing entities. For example, the predictive data analysis system 101 may provide the optimization function and the parameter occurrence combinations to one or more client computing entities 102. As described, the optimization function may include the predictive outcome function and the data type-specific derivation functions.

In some embodiments, the process 1000 includes, at step/operation 1030, generating an optimal parameter occurrence set. For example, the predictive data analysis system 101 may generate the optimal parameter occurrence set. In some embodiments, the optimal parameter occurrence set is indicative of a number of parameter occurrences of each of the plurality of outcome-influencing data types to allocate to the one or more data objects. In some embodiments, the plurality of predictive costs for the parameter occurrence combinations of the plurality of outcome-influencing data types are generated using the optimization function (e.g., which may include the predictive outcome function and data type-specific derivative functions). For example, the predictive data analysis system 101 may generate, using the optimization function, a plurality of predictive costs for the plurality of parameter occurrence combinations of the plurality of outcome-influencing data types. In some embodiments, an occurrence combination ranking of the plurality of parameter occurrence combinations is generated based on the plurality of predictive costs. For example, the predictive data analysis system 101 may generate an occurrence combination ranking of the plurality of parameter occurrence combinations based on the plurality of predictive costs. In some embodiments, the optimal parameter occurrence set is generated based on a top-ranked entry of the occurrence combination ranking. For example, the predictive data analysis system 101 may generate the optimal parameter occurrence set based on a top-ranked entry of the occurrence combination ranking.

Using the predictive data analysis techniques of the process 1000, additional optimal parameter occurrence sets may be generated for any number of data objects and outcome-influencing data types. As shown and described in the present disclosure, the optimal parameter occurrence sets may provide for utilization-efficient and cost-efficient allocations of type-varied resources to data objects. In this manner, the predictive data analysis techniques of the process 1000 may be practically applied to improve upon traditional resource allocation techniques that (i) rely on generic deterministic rules or associative frameworks, (ii) fail to identify and account for relationships between allocations of various combinations of resource types and a predictive outcome of a target objective, and (iii) incorrectly assume that data objects with the greatest risk of a negative event are also the data objects that may benefit most from additional allocations of parameter occurrences of various outcome-influencing data types.

In some embodiments, the process 1000 includes, at step/operation 1033, initiating the performance one or more predictive actions. For example, the predictive data analysis system 101 may initiate the performance of the one or more prediction actions. In another example, a client computing entity 102 may initiate the performance of the one or more prediction actions. Non-limiting examples of the prediction actions include (i) generating data constructs for allocating parameter occurrences of the plurality of outcome-influencing data types to the one or more data objects based on the optimal parameter occurrence set, (ii) generating a predictive cost metric for the predictive outcome based on the optimal parameter occurrence set, (iii) generating action scripts based on the optimal parameter occurrence set, and (iv) generating one or more electronic communications, graphical user interfaces, and/or visual renderings.

By way of example, in at least a clinical prediction domain context, the one or more predictive actions may include performing a resource-based action (e.g., allocation of resource), generating a diagnostic report, generating action scripts, generating alerts or messages, generating one or more electronic communications, and/or the like. The one or more predictive actions may further include displaying visual renderings of the aforementioned examples of predictive actions in addition to values, charts, and representations associated with the third-party data sources and/or third-party datasets thereof.

Some techniques of the present disclosure enable the generation of action outputs that may be performed to initiate one or more predictive actions to achieve real-world effects. The non-linear causal inference techniques of the present disclosure may be used, applied, and/or otherwise leveraged to generate optimal parameter occurrence sets for allocating an optimal number of parameter occurrences of a plurality of outcome-influencing data types to one or more data objects. These outputs may be leveraged to initiate the performance of various computing tasks that improve the performance of a computing system (e.g., a computer itself, etc.) with respect to various predictive actions performed by the computing system.

In some examples, the computing tasks may include predictive actions that may be based on a prediction domain. A prediction domain may include any environment in which computing systems may be applied to achieve real-word insights, such as predictions, and initiate the performance of computing tasks, such as predictive actions, to act on the real-world insights. These predictive actions may cause real-world changes, for example, by controlling a hardware component, providing targeted alerts, automatically allocating computing or human resources, and/or the like.

Examples of prediction domains may include financial systems, clinical systems, industrial processing systems, digital graphic rendering systems, autonomous systems, robotic systems, and/or the like. Predictive actions in such domains may include automated computing resource allocation actions, automated adjustments to computing and/or human resource management, the initiation of automated instructions across and between devices, automated notifications, automated scheduling operations, automated precautionary actions, automated security actions, automated data processing actions, automated server load balancing actions, and/or the like.

As one example, a prediction domain may include a clinical prediction domain. In such a case, the predictive actions may include automated allocation of clinical care resources and/or other resources to persons or healthcare programs, automated physician notification actions, automated patient notification actions, automated appointment scheduling actions, automated prescription recommendation actions, automated drug prescription generation actions, automated implementation of precautionary actions, automated record updating actions, automated datastore updating actions, automated hospital preparation actions, automated workforce management operational management actions, automated server load balancing actions, automated resource allocation actions, automated call center preparation actions, automated hospital preparation actions, automated pricing actions, automated healthcare program update actions, automated alert generation actions, and/or the like.

In some embodiments, the nonlinear causal inference and predictive data analysis techniques of the process 1000 are applied to initiate the performance of one or more predictive actions. As described herein, the predictive actions may depend on the prediction domain. In some examples, the process 1000 may leverage the nonlinear causal inference and data analysis prediction techniques to generate an optimal parameter occurrence set for allocating parameter occurrences of a plurality of outcome-influencing data objects to one or more data objects. Using the output optimal parameter occurrence set, the process 1000 may generate an action output that is optimized for achieving a target predictive outcome for the one or more data objects. These predictive insights may be leveraged to initiate the performance of the one or more predictive actions within a respective prediction domain. By way of example, the prediction domain may include a clinical prediction domain and the one or more predictive actions may include performing a resource-based action (e.g., allocation of resource), generating a diagnostic report, generating action scripts, generating alerts or messages, generating one or more electronic communications, and/or the like. The one or more predictive actions may further include displaying visual renderings of the aforementioned examples of predictive actions in addition to values, charts, and representations associated with the third-party data sources and/or third-party datasets thereof.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising identifying, by one or more processors, a plurality of outcome-influencing data types for a dataset comprising a plurality of data objects, wherein each of the plurality of data objects is associated with a number of parameter occurrences for each of the plurality of outcome-influencing data types; generating, by the one or more processors, a causal relationship representation based on the dataset, wherein the causal relationship representation is indicative of a causal relationship between each of the plurality of outcome-influencing data types and a predictive outcome of the plurality of data objects; generating, by the one or more processors, an optimization function using the causal relationship representation, wherein the optimization function is configured to generate an optimal parameter occurrence set for a data object of the plurality of data objects, and the optimal parameter occurrence set is indicative of an optimal number of parameter occurrences for each of the plurality of outcome-influencing data types; and providing, by the one or more processors, data indicative of the optimization function.

Example 2. The computer-implemented method of example 1, wherein the plurality of outcome-influencing data types are indicative of a plurality of different types of entity interactions between a party and the plurality of data objects, wherein each of the plurality of different types of entity interactions is associated with one or more interaction attributes.

Example 3. The computer-implemented method of example 2, wherein the one or more interaction attributes comprise at least one of a location attribute, a communication mode attribute, a temporal attribute, or a task attribute.

Example 4. The computer-implemented method of example 3, wherein the location attribute is indicative of at least one of a remote location, a local location, or a virtual location.

Example 5. The computer-implemented method of any of the preceding examples, wherein the optimization function is based on a rule set that is indicative of one or more party-specific parameters for constraining the optimal parameter occurrence set.

Example 6. The computer-implemented method of example 5, wherein the predictive outcome comprises a resource utilization metric and the optimal parameter occurrence set minimizes a predictive cost for the resource utilization metric.

Example 7. The computer-implemented method of any of the preceding examples, wherein generating the causal relationship representation comprises generating, by the one or more processors and using a non-parametric machine learning model, the causal relationship representation based on the dataset and a knowledge graph indicative of one or more relationships between the plurality of outcome-influencing data types and the predictive outcome.

Example 8. The computer-implemented method of example 7, wherein the knowledge graph is a directed acyclic graph and the non-parametric machine learning model is a double machine learning model.

Example 9. The computer-implemented method of any of the preceding examples, wherein the optimal number of parameter occurrences is indicative of a predictive cost metric for the predictive outcome.

Example 10. A computer apparatus comprising memory and one or more processors communicatively coupled to the memory, the one or more processors configured to identify a plurality of outcome-influencing data types for a dataset comprising a plurality of data objects, wherein each of the plurality of data objects is associated with a number of parameter occurrences for each of the plurality of outcome-influencing data types; generate a causal relationship representation based on the dataset, wherein the causal relationship representation is indicative of a causal relationship between each of the plurality of outcome-influencing data types and a predictive outcome of the plurality of data objects; generate an optimization function using the causal relationship representation, wherein the optimization function is configured to generate an optimal parameter occurrence set for a data object of the plurality of data objects, and the optimal parameter occurrence set is indicative of an optimal number of parameter occurrences for each of the plurality of outcome-influencing data types; and provide data indicative of the optimization function.

Example 11. The computer apparatus of example 10, wherein the plurality of outcome-influencing data types are indicative of a plurality of different types of entity interactions between a party and the plurality of data objects, wherein each of the plurality of different types of entity interactions is associated with one or more interaction attributes.

Example 12. The computer apparatus of example 11, wherein the one or more interaction attributes comprise at least one of a location attribute, a communication mode attribute, a temporal attribute, or a task attribute.

Example 13. The computer apparatus of example 12, wherein the location attribute is indicative of at least one of a remote location, a local location, or a virtual location.

Example 14. The computer apparatus of any of examples 10 through 14, wherein the optimization function is based on a rule set that is indicative of one or more party-specific parameters for constraining the optimal parameter occurrence set.

Example 15. The computer apparatus of example 14, wherein the predictive outcome comprises a resource utilization metric and the optimal parameter occurrence set minimizes a predictive cost for the resource utilization metric.

Example 16. One or more non-transitory, computer-readable storage media including instructions that, when executed by one or more processors, cause the one or more processors to identify a plurality of outcome-influencing data types for a dataset comprising a plurality of data objects, wherein each of the plurality of data objects is associated with a number of parameter occurrences for each of the plurality of outcome-influencing data types; generate a causal relationship representation based on the dataset, wherein the causal relationship representation is indicative of a causal relationship between each of the plurality of outcome-influencing data types and a predictive outcome of the plurality of data objects; generate an optimization function using the causal relationship representation, wherein the optimization function is configured to generate an optimal parameter occurrence set for a data object of the plurality of data objects, and the optimal parameter occurrence set is indicative of an optimal number of parameter occurrences for each of the plurality of outcome-influencing data types; and provide data indicative of the optimization function.

Example 17. The one or more non-transitory computer-readable storage media of example 16, wherein generating the causal relationship representation comprises generating, by the one or more processors and using a non-parametric machine learning model, the causal relationship representation based on the dataset and a knowledge graph indicative of one or more relationships between the plurality of outcome-influencing data types and the predictive outcome.

Example 18. The one or more non-transitory computer-readable storage media of example 17, wherein the knowledge graph is a directed acyclic graph and the non-parametric machine learning model is a double machine learning model.

Example 19. The one or more non-transitory computer-readable storage media of any of examples 16 through 18, wherein the optimal number of parameter occurrences is indicative of a predictive cost metric for the predictive outcome.

Example 20. The one or more non-transitory computer-readable storage media of examples 16 through 19, wherein the plurality of outcome-influencing data types are indicative of a plurality of different types of entity interactions between a party and the plurality of data objects, wherein each of the plurality of different types of entity interactions is associated with one or more interaction attributes.

1. A computer-implemented method comprising:
identifying, by one or more processors, a plurality of outcome-influencing data types for a dataset comprising a plurality of data objects, wherein each of the plurality of data objects is associated with a number of parameter occurrences for each of the plurality of outcome-influencing data types;
generating, by the one or more processors, a causal relationship representation based on the dataset, wherein the causal relationship representation is indicative of a causal relationship between each of the plurality of outcome-influencing data types and a predictive outcome of the plurality of data objects;
generating, by the one or more processors, an optimization function using the causal relationship representation, wherein:
the optimization function is configured to generate an optimal parameter occurrence set for a data object of the plurality of data objects, and
the optimal parameter occurrence set is indicative of an optimal number of parameter occurrences for each of the plurality of outcome-influencing data types; and
providing, by the one or more processors, data indicative of the optimization function.

2. The computer-implemented method of claim 1, wherein the plurality of outcome-influencing data types are indicative of a plurality of different types of entity interactions between a party and the plurality of data objects, wherein each of the plurality of different types of entity interactions is associated with one or more interaction attributes.

3. The computer-implemented method of claim 2, wherein the one or more interaction attributes comprise at least one of a location attribute, a communication mode attribute, a temporal attribute, or a task attribute.

4. The computer-implemented method of claim 3, wherein the location attribute is indicative of at least one of a remote location, a local location, or a virtual location.

5. The computer-implemented method of claim 1, wherein the optimization function is based on a rule set that is indicative of one or more party-specific parameters for constraining the optimal parameter occurrence set.

6. The computer-implemented method of claim 5, wherein the predictive outcome comprises a resource utilization metric and the optimal parameter occurrence set minimizes a predictive cost for the resource utilization metric.

7. The computer-implemented method of claim 1, wherein generating the causal relationship representation comprises generating, by the one or more processors and using a non-parametric machine learning model, the causal relationship representation based on the dataset and a knowledge graph indicative of one or more relationships between the plurality of outcome-influencing data types and the predictive outcome.

8. The computer-implemented method of claim 7, wherein the knowledge graph is a directed acyclic graph and the non-parametric machine learning model is a double machine learning model.

9. The computer-implemented method of claim 1, wherein the optimal number of parameter occurrences is indicative of a predictive cost metric for the predictive outcome.

10. A system comprising memory and one or more processors communicatively coupled to the memory, the one or more processors configured to:
identify a plurality of outcome-influencing data types for a dataset comprising a plurality of data objects, wherein each of the plurality of data objects is associated with a number of parameter occurrences for each of the plurality of outcome-influencing data types;
generate a causal relationship representation based on the dataset, wherein the causal relationship representation is indicative of a causal relationship between each of the plurality of outcome-influencing data types and a predictive outcome of the plurality of data objects;
generate an optimization function using the causal relationship representation, wherein:
the optimization function is configured to generate an optimal parameter occurrence set for a data object of the plurality of data objects, and
the optimal parameter occurrence set is indicative of an optimal number of parameter occurrences for each of the plurality of outcome-influencing data types; and
provide data indicative of the optimization function.

11. The system of claim 10, wherein the plurality of outcome-influencing data types are indicative of a plurality of different types of entity interactions between a party and the plurality of data objects, wherein each of the plurality of different types of entity interactions is associated with one or more interaction attributes.

12. The system of claim 11, wherein the one or more interaction attributes comprise at least one of a location attribute, a communication mode attribute, a temporal attribute, or a task attribute.

13. The system of claim 12, wherein the location attribute is indicative of at least one of a remote location, a local location, or a virtual location.

14. The system of claim 10, wherein the optimization function is based on a rule set that is indicative of one or more party-specific parameters for constraining the optimal parameter occurrence set.

15. The system of claim 14, wherein the predictive outcome comprises a resource utilization metric and the optimal parameter occurrence set minimizes a predictive cost for the resource utilization metric.

16. One or more non-transitory, computer-readable storage media including instructions that, when executed by one or more processors, cause the one or more processors to:
identify a plurality of outcome-influencing data types for a dataset comprising a plurality of data objects, wherein each of the plurality of data objects is associated with a number of parameter occurrences for each of the plurality of outcome-influencing data types;
generate a causal relationship representation based on the dataset, wherein the causal relationship representation is indicative of a causal relationship between each of the plurality of outcome-influencing data types and a predictive outcome of the plurality of data objects;
generate an optimization function using the causal relationship representation, wherein:
the optimization function is configured to generate an optimal parameter occurrence set for a data object of the plurality of data objects, and
the optimal parameter occurrence set is indicative of an optimal number of parameter occurrences for each of the plurality of outcome-influencing data types; and
provide data indicative of the optimization function.

17. The one or more non-transitory computer-readable storage media of claim 16, wherein generating the causal relationship representation comprises generating, by the one or more processors and using a non-parametric machine learning model, the causal relationship representation based on the dataset and a knowledge graph indicative of one or more relationships between the plurality of outcome-influencing data types and the predictive outcome.

18. The one or more non-transitory computer-readable storage media of claim 17, wherein the knowledge graph is a directed acyclic graph and the non-parametric machine learning model is a double machine learning model.

19. The one or more non-transitory computer-readable storage media of claim 16, wherein the optimal number of parameter occurrences is indicative of a predictive cost metric for the predictive outcome.

20. The one or more non-transitory computer-readable storage media of claim 16, wherein the plurality of outcome-influencing data types are indicative of a plurality of different types of entity interactions between a party and the plurality of data objects, wherein each of the plurality of different types of entity interactions is associated with one or more interaction attributes.
